(19) United States
(12) Patent Application Publication
(10) Pub. No.: US 2023/0369686 A1
(43) Pub. Date: Nov. 16, 2023

(54) BATTERY ASSEMBLIES, COMPONENTS THEREOF, AND METHODS OF MANUFACTURE

(71) Applicant: EAGLEPICHER TECHNOLOGIES, LLC, Joplin, MO (US)

(72) Inventors: Frank PUGLIA, Joplin, MO (US); Robert S. DOUGLAS, Joplin, MO (US); Jeffrey C. HALL, Joplin, MO (US); Michael CAVANAGH, Joplin, MO (US); Kenneth M. CAVANAGH, Joplin, MO (US); Lawrence RUDDOCK, Joplin, MO (US); Stuart SANTEE, Joplin, MO (US); Shawn CARY, Joplin, MO (US); Brian CHIOU, Joplin, MO (US)

(21) Appl. No.: 18/030,363

(22) PCT Filed: Oct. 4, 2021
(86) PCT No.: PCT/US2021/053315

§ 371 Date: Apr. 5, 2023

Related U.S. Application Data
(60) Provisional application No. 63/087,446, filed on Oct. 5, 2020.

(51) Int. Cl. H01M 50/103; H01M 50/133; H01M 50/105; H01M 50/367; H01M 10/647; H01M 10/658; H01M 50/244; H01M 50/209; H01M 50/264; H01M 10/6571

(52) U.S. Cl. CPC H01M 50/103; H01M 50/133; H01M 50/105; H01M 50/367; H01M 10/647; H01M 10/658; H01M 50/244; H01M 50/209; H01M 50/264; H01M 10/6571

(57) ABSTRACT

Battery cells, battery cell units, battery modules, and battery assemblies are described. The cells of such components include a prismatic shaped cell housing including a slanted wall. Substantially planar positive and negative electrodes are arranged within the housing. The slanted wall defines a pocket within the housing between edges of the electrodes and an interior surface of the slanted wall and the pocket is configured to collect gas generated within the housing. A vent is formed on the slanted wall of the housing proximate the pocket. The vent is initially in a closed state and configured to open upon an increase in pressure within the housing to allow pressure and/or gases to leave the cell cavity through the vent. The battery cell units, battery modules, and battery assemblies may include such cells.

### CROSS REFERENCE TO RELATED APPLICATIONS

This application claims priority to and the benefit of U.S. Provisional Application No. 63/087,446, filed on Oct. 5, 2020, which is incorporated herein by reference in its entirety.

### BACKGROUND OF THE INVENTION

The embodiments herein relate to batteries, battery assemblies, and components thereof.

Batteries are used for storing and supplying electrical power. Batteries may be combined into assemblies having multiple batteries used for storing and supplying greater quantities of power, such as in high rate discharge applications. A high rate discharge battery assembly may include a large number of battery units or cells along with framing and support to allow for compact physical storage and use. During a high rate of discharge, a substantial amount of heat may be generated, and thus cooling mechanisms may be desirable to ensure detrimental impacts from excessive heat are avoided. Improved systems for cells and battery assemblies may be advantageous to enable safe, high rate discharge systems.

### BRIEF DESCRIPTION OF THE INVENTION

According to the present disclosure, cells, cell units, battery modules, and battery assemblies are shown and described.

According to some embodiments, cells are provided. The cells include a prismatic shaped cell housing comprising a first portion and a second portion and defining a cell cavity between the first portion and the second portion, wherein cell housing includes a slanted wall, at least one positive electrode and at least one negative electrode arranged within the cell cavity of the cell housing, wherein the at least one positive and negative electrodes are substantially planar and have a prismatic shape substantially similar to that of the cell housing, a first terminal connected to the at least one positive electrode at a first position on the cell housing, a second terminal connected to the at least one negative electrode at a second position of the cell housing, wherein the slanted wall defines a pocket within the cell housing between edges of the at least one positive electrode and the at least one negative electrode and an interior surface of the slanted wall, wherein the pocket is configured to collect gas generated within the cell housing, and at least one vent formed at a third position on the slanted wall of the cell housing proximate the pocket, wherein the at least one vent is initially in a closed state and configured to open upon an increase in pressure within the cell cavity and allow pressure and/or gases to leave the cell cavity through the at least one vent.

In addition to one or more of the features described herein, or as an alternative, further embodiments of the cells may include that the slanted wall includes one of a convex and a concave curvature.

In addition to one or more of the features described herein, or as an alternative, further embodiments of the cells may include that the cell housing has a thickness in a direction from the first portion to the second portion, wherein said thickness is 0.5 inches or less.

In addition to one or more of the features described herein, or as an alternative, further embodiments of the cells may include that the first portion of the cell housing and the second portion of the cell housing are two portions of a single sheet of material that is folded to define the cell cavity.

In addition to one or more of the features described herein, or as an alternative, further embodiments of the cells may include that the first portion is attached to the second portion by at least one of welding, ultrasonic welding, adhesives, crimping, heat sealing, or bonding.

In addition to one or more of the features described herein, or as an alternative, further embodiments of the cells may include that each of the first portion and the second portion each include a respective flange and the flanges of the first portion and the second portion are one of jointed or hinged to form a clam-shell configuration.

In addition to one or more of the features described herein, or as an alternative, further embodiments of the cells may include that each of the first portion and the second portion each include a respective flange and the flanges of the first portion and the second portion are joined to form a bathtub or elongated hemispherical configuration.

In addition to one or more of the features described herein, or as an alternative, further embodiments of the cells may include that the at least one positive electrode and the at least one negative electrode each comprise a plurality of respective electrodes arranged in an electrode stack of alternating positive and negative electrodes.

In addition to one or more of the features described herein, or as an alternative, further embodiments of the cells may include that the at least one vent is integrally formed with material of the cell housing.

In addition to one or more of the features described herein, or as an alternative, further embodiments of the cells may include that the at least one vent is defined by a section of the cell housing having a material thickness less than a material thickness of the cell housing around the at least one vent.

In addition to one or more of the features described herein, or as an alternative, further embodiments of the cells may include that the slanted wall includes at least one additional vent.

In addition to one or more of the features described herein, or as an alternative, further embodiments of the cells may include that the at least one positive electrode and the at least one negative electrode each comprise a plurality of respective electrodes arranged in an electrode stack, the cell further comprising at least one interior housing insulator element arranged between a side of the electrode stack and at least one of the first portion or the second portion.

In addition to one or more of the features described herein, or as an alternative, further embodiments of the cells may include that the at least one interior housing insulator element is comprises at least one of a polyolefin, a fluorinated polyolefin, or a tape formed thereof.

In addition to one or more of the features described herein, or as an alternative, further embodiments of the cells may include that the at least one positive electrode and the at least one negative electrode each comprise a plurality of respective electrodes divided into two or more electrode groups, the cell further comprising at least one divider arranged between each electrode group and an adjacent electrode group.

In addition to one or more of the features described herein, or as an alternative, further embodiments of the cells may include that the at least one divider comprises a thermal conductor layer, a thermal insulator layer, or a combination of a thermal conductor layer and a thermal insulator layer.

In addition to one or more of the features described herein, or as an alternative, further embodiments of the cells may include that a vent of the at least one vent has a rectilinear, curvilinear, or circular shape.

In addition to one or more of the features described herein, or as an alternative, further embodiments of the cells may include that a vent of the at least one vent has a wave-shape having at least one peak and at least one trough.

In addition to one or more of the features described herein, or as an alternative, further embodiments of the cells may include that the first portion is a first side of a pouch and the second portion is a second side of the pouch with a midsection defined between the first side and the second side.

In addition to one or more of the features described herein, or as an alternative, further embodiments of the cells may include that the midsection includes one or more terminal apertures configured to allow electrical connection between the first and second terminals and the at least one positive electrode and the at least one negative electrode.

According to some embodiments, cell units are provided. The cell units include a cell comprising at least one positive electrode arranged within a cell housing and electrically connected to a first terminal and at least one negative electrode arranged within the cell housing and electrically connected to a second terminal, wherein the first terminal extends from the cell housing at a first position and the second terminal extends from the cell housing at a second position, and a unit frame configured to receive and support the cell, the unit frame having at least one open section configured to receive the first terminal and the second terminal and provide access thereto, wherein the unit frame comprises a recess on the frame arranged away from the at least one open section, the recess configured to collect and direct gas away from the cell in the event of a leak of gas from the cell, the unit frame having a dimension in a direction that in in-plane with the cell when installed within the frame, wherein the dimension is between 0.05 inch and 0.5 inch, inclusive.

In addition to one or more of the features described herein, or as an alternative, further embodiments of the cell units may include that the unit frame comprises a base, a first arm, a second arm, and an open end opposite the base defined by the at least one open section.

In addition to one or more of the features described herein, or as an alternative, further embodiments of the cell units may include that the unit frame defines a plurality of corners at ends of the arms and at junctions of the arms with the base, and the unit frame includes a mounting feature at each of the corners.

In addition to one or more of the features described herein, or as an alternative, further embodiments of the cell units may include that the cell includes at least one vent at a third position and the at least one vent is substantially aligned with the recess of the unit frame.

In addition to one or more of the features described herein, or as an alternative, further embodiments of the cell units may include that the at least one vent is integrally formed with a material of the cell housing.

In addition to one or more of the features described herein, or as an alternative, further embodiments of the cell units may include that the unit frame includes at least one alignment feature configured to engage with another cell unit.

In addition to one or more of the features described herein, or as an alternative, further embodiments of the cell units may include at least one cell insulator arranged on a side of the cell unit, the at least one cell insulator being electrically insulative.

In addition to one or more of the features described herein, or as an alternative, further embodiments of the cell units may include that the at least one cell insulator is thermally conductive.

In addition to one or more of the features described herein, or as an alternative, further embodiments of the cell units may include that the at least one cell insulator comprises at least one of a polyimide or a polyester.

In addition to one or more of the features described herein, or as an alternative, further embodiments of the cell units may include that the unit frame is formed of a non-flammable material.

In addition to one or more of the features described herein, or as an alternative, further embodiments of the cell units may include a unit wrap structure wrapped about the cell and the unit frame to retain the cell within the unit frame.

In addition to one or more of the features described herein, or as an alternative, further embodiments of the cell units may include that unit wrap structure is a sheet of material having a toothed geometry at opposing ends thereof.

In addition to one or more of the features described herein, or as an alternative, further embodiments of the cell units may include that the unit wrap structure comprises two sheets of material wrapped about the cell and the unit frame.

In addition to one or more of the features described herein, or as an alternative, further embodiments of the cell units may include that the unit wrap structure comprises a single sheet of material wrapped multiple times around the cell within the unit frame.

In addition to one or more of the features described herein, or as an alternative, further embodiments of the cell units may include an insulator element applied to an exterior surface of the unit wrap structure.

In addition to one or more of the features described herein, or as an alternative, further embodiments of the cell units may include that the unit frame comprises at least one air gap defined by a channel within a portion of the unit frame.

In addition to one or more of the features described herein, or as an alternative, further embodiments of the cell units may include at least one mounting feature defining a through-hole for receiving a structure to assembly the cell unit with additional other cell units.

In addition to one or more of the features described herein, or as an alternative, further embodiments of the cell units may include that the at least one mounting feature comprises a boss.

In addition to one or more of the features described herein, or as an alternative, further embodiments of the cell units may include that the cell housing comprises a flange configured to overlap with at least a portion of the unit frame.

In addition to one or more of the features described herein, or as an alternative, further embodiments of the cell units may include that an air gap is defined between the flange and the portion of the unit frame the flange overlaps.

According to some embodiments, battery modules are provided. The battery modules include a first end plate and a second end plate configured to support one or more tie rods therebetween, a plurality of cell units attached to the one or more tie rods and compressively loaded between the first end plate and the second end plate, wherein each cell unit comprises a unit frame and a cell installed within the unit frame, wherein the cell includes a vent configured to direct gas away from an interior of the cell and the unit frame includes a recess aligned with the vent and configured to direct the gas away from the cell and the unit frame, and each cell unit comprises an insulator and a unit wrap structure wrapped about the cell, the frame, and the insulator, and an insulator element arranged between adjacent cell units of the plurality of cell units. All of the cell units of the plurality of cell units are oriented so that the vents are on a side of the cell unit that does not include terminals of the cell units.

In addition to one or more of the features described herein, or as an alternative, further embodiments of the battery modules may include that the plurality of cell units define at least a first group of cell units and a second group of cell units, the battery module further comprising a firewall arranged between the first group of cell units and the second group of cell units.

In addition to one or more of the features described herein, or as an alternative, further embodiments of the battery modules may include that the firewall is mounted to the one or more tie rods.

In addition to one or more of the features described herein, or as an alternative, further embodiments of the battery modules may include that the insulator element is formed of a material having low thermal conductivity and low or no flammability.

In addition to one or more of the features described herein, or as an alternative, further embodiments of the battery modules may include a thermal transfer device arranged along a side of the plurality of cell units and arranged in contact and thermal communication with the unit wrap structure of at least two cell units to distribute heat between the cell units the thermal transfer device is in contact with.

In addition to one or more of the features described herein, or as an alternative, further embodiments of the battery modules may include that the thermal transfer device is formed of at least one of aluminum, pyrolytic graphite, diamond, graphene, or copper.

In addition to one or more of the features described herein, or as an alternative, further embodiments of the battery modules may include that the thermal transfer device includes one or more heat pipes.

In addition to one or more of the features described herein, or as an alternative, further embodiments of the battery modules may include that the thermal transfer device is attached to the battery module by an a thermally conductive adhesive.

In addition to one or more of the features described herein, or as an alternative, further embodiments of the battery modules may include a heater installed on the thermal transfer device.

In addition to one or more of the features described herein, or as an alternative, further embodiments of the battery modules may include that the thermal transfer device is a plate structure or sheet of material.

In addition to one or more of the features described herein, or as an alternative, further embodiments of the battery modules may include that the plurality of cell units includes a first cell unit adjacent a second cell unit, wherein a tray vent structure is defined by the adjacent first and second cell units, wherein the tray vent structure is configured to collect and direct gases vented from one or both of the first and second cell units.

In addition to one or more of the features described herein, or as an alternative, further embodiments of the battery modules may include that each cell unit of the plurality of cell units includes a cell comprising at least one positive electrode arranged within a cell housing and electrically connected to a first terminal and at least one negative electrode arranged within the cell housing and electrically connected to a second terminal, wherein the first terminal extends from the cell housing at a first position and the second terminal extends from the cell housing at a second position, and a unit frame configured to receive and support the cell, the unit frame having a first open section configured to receive the first terminal and a second open section configured to receive the second terminal and provide access thereto.

In addition to one or more of the features described herein, or as an alternative, further embodiments of the battery modules may include that each cell unit of the plurality of cell units includes a cell housing comprising a first portion and a second portion and defining a cell cavity between the first portion and the second portion, at least one positive electrode and at least one negative electrode arranged within the cell cavity of the cell housing, a first terminal connected to the at least one positive electrode at a first position on the cell housing, a second terminal connected to the at least one negative electrode at a second position of the cell housing, at least one vent formed at a third position on the cell housing, wherein the at least one vent is initially in a closed state and configured to open upon an increase in pressure within the cell cavity and allow pressure and/or gases to leave the cell cavity through the at least one vent.

According to some embodiments, battery assemblies are provided. the battery assemblies include an assembly frame, a first battery module, and a second battery module arranged within the assembly frame. Each battery module includes a first end plate and a second end plate configured to support one or more tie rods therebetween, a plurality of cell units attached to the one or more tie rods and compressively loaded between the first end plate and the second end plate, wherein each cell unit comprises a unit frame and a cell installed within the unit frame, wherein the cell includes a vent configured to direct gas away from an interior of the cell and the unit frame includes a recess aligned with the vent and configured to direct the gas away from the cell and the unit frame, and each cell unit comprises an insulator and a unit wrap structure wrapped about the cell, the frame, and the insulator, and an insulator element arranged between adjacent cell units of the plurality of cell units. All of the cell units of the plurality of cell units are oriented so that the vents are on a side of the cell unit that does not include terminals of the cell units. An electrical connector electrically connects the first battery module to the second battery module.

In addition to one or more of the features described herein, or as an alternative, further embodiments of the battery assemblies may include that the assembly frame comprises one or more end support rails configured to support at least one of the first battery module or the second battery module within the assembly frame.

In addition to one or more of the features described herein, or as an alternative, further embodiments of the battery assemblies may include that the one or more end support rails have an ell-shape in cross-section.

In addition to one or more of the features described herein, or as an alternative, further embodiments of the battery assemblies may include that the assembly frame comprises one or more center support rails configured to support each of the first battery module and the second battery module within the assembly frame.

In addition to one or more of the features described herein, or as an alternative, further embodiments of the battery assemblies may include that the one or more center support rails have a tee-shape in cross-section.

In addition to one or more of the features described herein, or as an alternative, further embodiments of the battery assemblies may include that the electrical connector is a wire or a bus bar.

In addition to one or more of the features described herein, or as an alternative, further embodiments of the battery assemblies may include that each cell unit of the plurality of cell units includes a cell comprising at least one positive electrode arranged within a cell housing and electrically connected to a first terminal and at least one negative electrode arranged within the cell housing and electrically connected to a second terminal, wherein the first terminal extends from the cell housing at a first position and the second terminal extends from the cell housing at a second position, and a unit frame configured to receive and support the cell, the unit frame having a first open section configured to receive the first terminal and a second open section configured to receive the second terminal and provide access thereto.

In addition to one or more of the features described herein, or as an alternative, further embodiments of the battery assemblies may include that each cell unit of the plurality of cell units includes a cell housing comprising a first portion and a second portion and defining a cell cavity between the first portion and the second portion, at least one positive electrode and at least one negative electrode arranged within the cell cavity of the cell housing, a first terminal connected to the at least one positive electrode at a first position on the cell housing, a second terminal connected to the at least one negative electrode at a second position of the cell housing, at least one vent formed at a third position on the cell housing, wherein the at least one vent is initially in a closed state and configured to open upon an increase in pressure within the cell cavity and allow pressure and/or gases to leave the cell cavity through the at least one vent.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be illustrative and explanatory in nature and non-limiting.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic illustration of a cell that can incorporate embodiments of the present disclosure or be incorporated into embodiments of the present disclosure;

FIG. 2A is a schematic illustration of a cell in accordance with an embodiment of the present disclosure;

FIG. 2B is an unassembled illustration of the cell of FIG. 2A;

FIG. 2C is an alternative view of the cell of FIG. 2A;

FIG. 3A is a schematic cross-section illustration of a cell housing for a cell in accordance with an embodiment of the present disclosure;

FIG. 3B is a schematic cross-section illustration of a cell housing for a cell in accordance with an embodiment of the present disclosure;

FIG. 4A is a schematic cross-section illustration of a cell in accordance with an embodiment of the present disclosure;

FIG. 4B is a schematic cross-section illustration of an alternative cell configuration in accordance with an embodiment of the present disclosure;

FIG. 5A is a schematic illustration of cell configurations in accordance with an embodiment of the present disclosure;

FIG. 5B is a schematic illustration of cell configurations in accordance with an embodiment of the present disclosure;

FIG. 5C is a schematic illustration of cell configurations in accordance with an embodiment of the present disclosure;

FIG. 5D is a schematic illustration of cell configurations in accordance with an embodiment of the present disclosure;

FIG. 5E is a schematic illustration of cell configurations in accordance with an embodiment of the present disclosure;

FIG. 5F is a schematic illustration of cell configurations in accordance with an embodiment of the present disclosure;

5G is a schematic illustration of a cell configuration in accordance with an embodiment of the present disclosure;

FIG. 6A is a schematic illustration of a cell in accordance with an embodiment of the present disclosure;

FIG. 6B illustrates various geometries of vents for use with cells in accordance with the present disclosure;

FIG. 7A is a schematic illustration of a cell in accordance with an embodiment of the present disclosure;

FIG. 7B is a schematic illustration of a portion of the cell of FIG. 7A;

FIG. 7C is a schematic illustration of a portion of the cell of FIG. 7A;

FIG. 7D is a schematic illustration of a portion of the cell of FIG. 7A;

FIG. 8A is a schematic illustration of a cell unit in an unassembled state in accordance with an embodiment of the present disclosure;

FIG. 8B is a schematic illustration of the cell unit of FIG. 8A;

FIG. 8C is a schematic illustration of the cell unit of FIG. 8A;

FIG. 8D is a schematic illustration of the cell unit of FIG. 8A;

FIG. 8E is an enlarged schematic illustration of a portion of the cell unit of FIG. 8A;

FIG. 8F is a cross section illustration of the cell unit of FIG. 8A;

FIG. 9A is a schematic illustration of a cell unit in accordance with an embodiment of the present disclosure;

FIG. 9B is a schematic illustration of portions of the cell unit of FIG. 9A;

FIG. 9C is a schematic illustration of different wrapping configurations in accordance with embodiments of the present disclosure;

FIG. 10 is a schematic illustration of a cell unit in accordance with an embodiment of the present disclosure;

FIG. 11A is a cross-sectional view of the cell unit of in accordance with an embodiment of the present disclosure;

FIG. 11B is a cross-sectional view of the cell unit of FIG. 11A as viewed along the line B-B indicated in FIG. 11A;

FIG. 12A is a schematic illustration of a battery module in accordance with an embodiment of the present disclosure;

FIG. 12B is a schematic illustration of the battery module of FIG. 12A during assembly;

FIG. 12C is a schematic illustration of the battery module of FIG. 12A during assembly;

FIG. 13 is a schematic illustration of a battery module in accordance with an embodiment of the present disclosure;

FIG. 14 is a schematic illustration of firewalls for use with battery modules in accordance with embodiments of the present disclosure;

FIG. 15A is a schematic illustration of a portion of a battery module in accordance with an embodiment of the present disclosure;

FIG. 15B is an alternative view of the battery module of FIG. 15A;

FIG. 16 illustrates schematic configurations of a battery module in accordance with an embodiment of the present disclosure;

FIG. 17A is a schematic illustration of a battery assembly in accordance with an embodiment of the present disclosure;

FIG. 17B is a schematic illustration of a portion of the battery assembly of FIG. 17A during assembly;

FIG. 17C is a schematic illustration of the battery assembly of FIG. 17A during assembly; and

FIG. 17D is a schematic illustration of the battery assembly of FIG. 17A.

### DETAILED DESCRIPTION OF THE INVENTION

Electrochemical cells are used for storing and supplying electrical power. A plurality of cells may be combined into assemblies, such as a battery, having multiple cells used for storing and supplying high quantities of power, such as in high rate discharge applications. In a battery, the cells may be connected in any suitable combination of series and parallel connections. High rate discharge battery assemblies may require a large number of cells along with framing and support to allow for compact physical storage and use. During a high rate of discharge, cells and other components in the battery assembly may generate a substantial amount of heat, and thus cooling mechanisms may be desirable to avoid detrimental effects from excessive heat. Improved configurations and systems may be advantageous to enable safe, high rate discharge systems. Embodiments of the present disclosure are directed to improved cells, batteries, battery systems, and battery assemblies. The disclosed cells, batteries, and systems can provide improved power density, desirable for applications that value a compact, high discharge supply of electric power. It will be appreciated that although high rate discharge and the like is enabled by embodiments of the present disclosure, embodiments disclosed herein are not limited to high rate applications and may be used for any type of power storage.

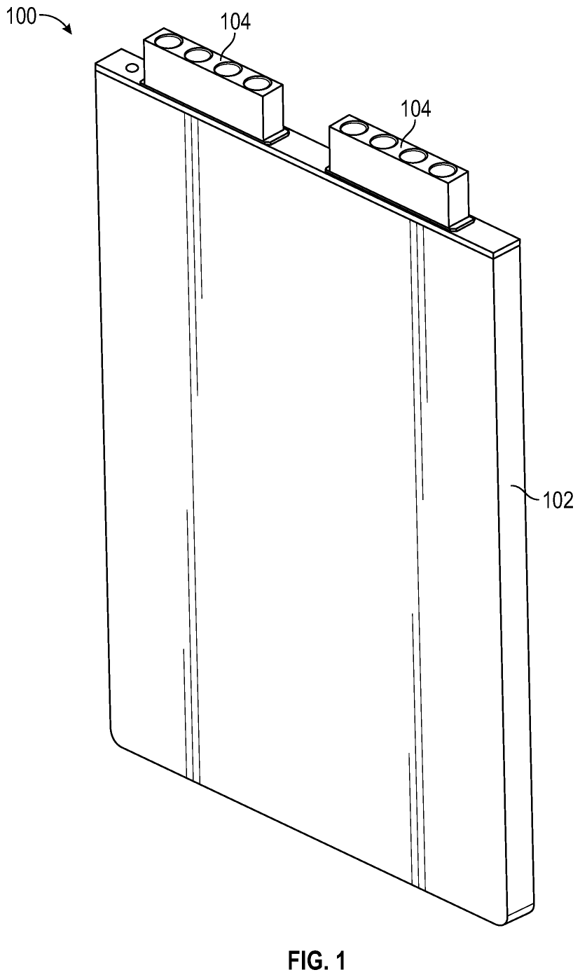

Referring to FIG. 1, a schematic illustration of a cell 100 that may incorporate embodiments of the present disclosure is shown. The cell 100 includes a cell housing 102 and terminals 104. The cell housing 102 is configured to contain one or more positive and negative electrodes (e.g., in the form of a stack or set of internal electrochemical elements) that can be charged and discharged by electrical energy through the terminals 104. In some embodiments, the electrode configuration can include a single positive electrode and a single negative electrode. In other embodiments, a stack of positive and negative electrodes may be employed. Although shown as having two terminals 104, it will be appreciated that the present disclosure applied to other configurations, including single terminal cells in the case of polarized designs. Other internal electrochemical configurations are possible without departing from the scope of the present disclosure. In some embodiments, the cell 100 may be a lithium-ion cell. As is further disclosed herein, improved thermal control may be achieved.

The cell housing 102 is a prismatic shaped cell housing, and in turn the cell 100 is a prismatic shaped cell. As used herein “prismatic shape” refers to non-cylindrical shapes and that the cell has a substantially planar orientation of electrodes. The cell housing and the electrodes within the cell housing will have substantially the same shape/geometry, and thus a prismatic shaped cell housing will include prismatic shaped, substantially planar electrodes therein.

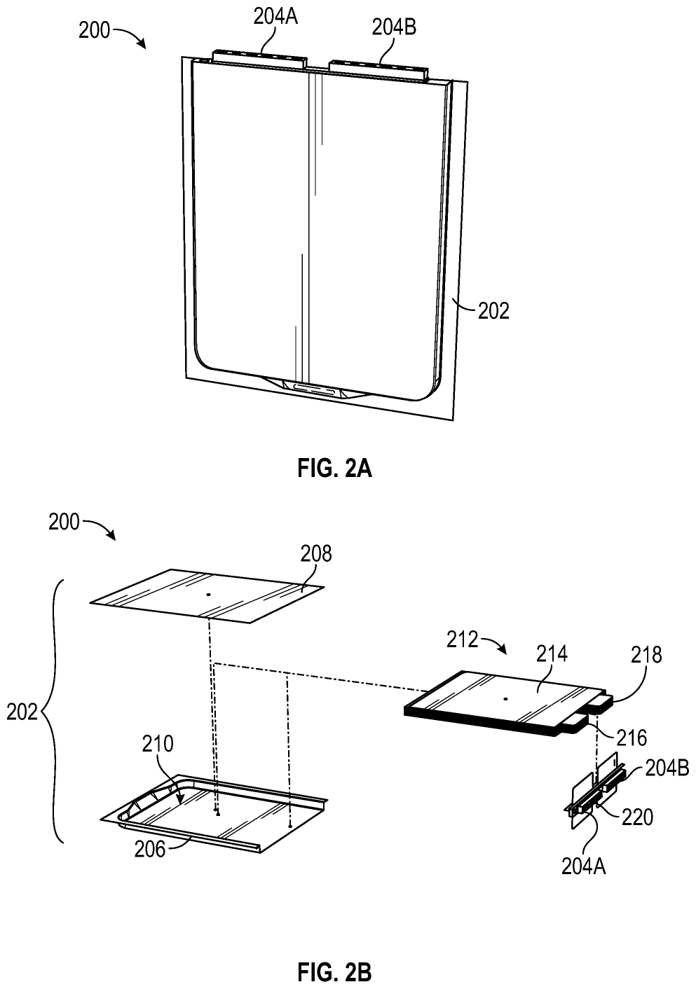

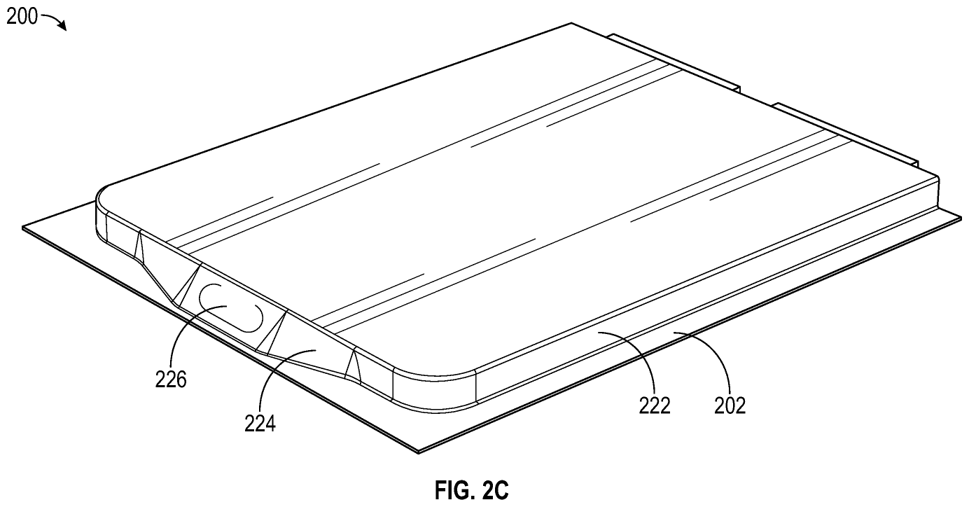

For example, turning now to FIGS. 2A-2C, schematic illustrations of a cell 200 in accordance with an embodiment of the present disclosure are shown. FIG. 2A is a perspective view of the cell 200, FIG. 2B is an unassembled illustration of the cell 200, and FIG. 2C is an alternative perspective view of the cell 200. The cell 200 includes a cell housing 202 and terminals 204A, 204B extending therefrom.

As shown in FIG. 2B, the cell housing 202 includes a first portion 206 and a second portion 208. The portions 206, 208 of the cell housing 202 may be attached or otherwise connected. Such connection or attachment may be by welding, ultrasonic welding, adhesives, crimping, bonding, heat sealing, or other chemical, material, mechanical connection/attachment or combinations thereof. The first portion 206 defines a cell cavity 210 configured to receive components of the cell 200. Although shown with the first portion 206 defining the cell cavity 210, in other embodiments, the second portion or a combination of the first portion and the second portion may be arranged to define the cell cavity. The portions 206, 208 of the cell housing 202 may be formed from, in some non-limiting examples, aluminum, stainless steel, or heat-sealable laminate thereof.

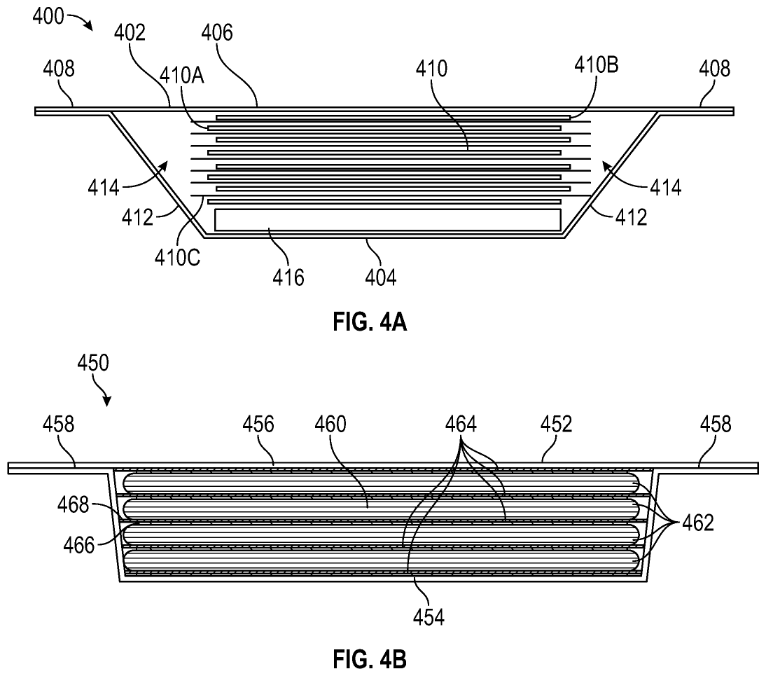

An electrode stack 212 is configured to fit within and be retained within the cell cavity 210 between the first portion 206 and the second portion 208 of the cell housing 202. The electrode stack 212 is formed of a plurality of cell elements such as electrodes 214, such as positive and negative electrodes (e.g., cathodes and anodes) and can include a separator between each positive and negative electrode. The separator may be a microporous separator, for example. The electrode stack 212 includes a first tab 216 and a second tab 218, which allow for electrical connection and electrical power transfer to and from the electrodes 214. The electrodes comprise positive and negative electrodes, shown in further detail, for example, in FIG. 4A. In some configurations, the first tab 216 may be a negative tab, and may comprise nickel or copper, for example, and the second tab 218 may be a positive tab, and may comprise aluminum, for example. In a non-limiting example, the electrode stack 212 may include positive electrodes having an aluminum current collector and cathode active material, negative electrodes with a copper current collector with anode active material, a separator between the electrodes (e.g., microporous polyethylene), and an electrolyte comprising a suitable lithium salt in a suitable organic solvent. It will be appreciated that each of the first and second tabs 216, 218 may be formed of a single tab or multiple (e.g., stacked) tabs, for each of them, depending on the specific cell configuration and/or application.

A terminal block 220 comprises a negative terminal 204A and a positive terminal 204B. The negative terminal 204A and the positive terminal 204B are electrically insulated from each other. The negative terminal 204A and the positive terminal 204B may be electrically connected to the first tab 216 and the second tab 218, respectively, of the electrode stack 212 to enable a connector to provide a suitable connection for electrical power transfer to or from the electrode stack 212. The terminal block 220 includes the terminals 204A and 204B of the cell 200. In some embodiments, the tabs 216, 218 may be affixed to portions of the terminal block 220, such as by welded connection (e.g., ultrasonic, laser, resistance, etc.), rivets, fasteners, or other types of connectors and/or connections.

Although shown in FIG. 2B with an open end of the first portion 206 being on a short dimension such arrangement is not to be limiting. For example, rather than the short dimension being open, in some embodiments, the electrode stack 212 may be inserted into the cell housing along a long dimension of the cell housing. Further, it will be appreciated that the tabs 216, 218 may extend from the long dimension of the electrode stack 212, rather than from the short dimension as shown in FIG. 2B. Further, although the first portion 206 and the second portion 208 are shown as completely separate structures that are configured to be attached together, in some embodiments, the two portions 206, 208 may be a single material structure, and for example, the second portion 208 may be folded over the first portion 206 and then joined together.

Referring to FIG. 2C, the cell housing 202 includes housing sidewalls 222 that may define, in part, the cell cavity 210. As shown, at one end of the formed cell housing 202, the housing sidewalls 222 may include a slanted housing sidewall 224. The slanted housing sidewall 224, in this embodiment, includes a vent 226. Although shown in FIGS. 2A-2C with the slanted housing sidewall 224 only at one location, it will be appreciated that the slanted housing sidewall 224 can extend around a larger portion or the entire length of the housing sidewalls 222, and the configuration shown in the illustrations is merely provided for illustrative and explanatory purposes. The slanted housing sidewall of embodiments of the present disclosure may have a slant angle of between, for example, 30° and 90° (i.e., less than 90°, e.g., 35° to 80°, 40° to 70°, etc.), although any desired angle may be employed without limitation. In some embodiments, the slanted housing sidewalls 224 may include curvatures or the like (e.g., concave or convex) and thus is not limited to being a planar surface that is slanted. As such, and as used herein, the term “slanted sidewall” or “slanted housing sidewall” is not limited to planar surfaces, but can be contoured, curved, or otherwise shaped.

Further, the flat portions of the housing sidewalls 222 may be provided about the majority of the periphery or only some portions thereof. Additionally, in some embodiments, a vent may be installed or configured along a section of flat sidewall and is not required to be provided on a slanted housing sidewall 224.

The vent 226 may be configured to open upon an increase in pressure within the cell housing 202 and thus allow for venting of pressure and/or gasses from within the cell housing 202. As shown in FIGS. 2A-2C, the vent 226 is arranged at an opposite side of the cell housing 202 from the terminals 204A and 204B. Such placement of the vent 226 at the end opposite the terminals 204A and 204B and arranged on the slanted housing sidewall 224 may allow for an improved configuration to provide additional space at the terminal end of the cell 200. For example, relatively larger terminals may be employed as compared to alternative designs. Further, due to the slanted housing sidewall 224, gas can be collected and directed more efficiently through the vent 226 and away from sensitive parts of the battery, cell, or cell unit. It will be appreciated that the location and number of vents may be selected based on a specific cell housing design or cell design.

Having the vent 226 arranged on the slanted housing sidewall 224 can increase a surface area against which the vent 226 can act. In some embodiments, the vent 226 may be an integral piece of the material of the cell housing 202, such as an etched vent (e.g., provided by laser etching, chemical etching, photo etching, mechanical etching, etc.) or a vent structure formed of a reduced thickness of material at the location of the vent 226 (e.g., coining, machining, stamping, milling, etc.). As such, in some embodiments, the vent 226 may not be a separate piece of material attached to the cell housing 202. The forming of the vent 226 may be such that the vent 226 has a trench or reduced material thickness at the location of the vent 226. For example, the thickness of the material at the vent 226 may have any value that is less than a material thickness of the cell housing 202 at non-vent locations. For example, and without limitation, the material thickness of the vent 226 (e.g., residual thickness after formation of vent structure) may be 0.0001, 0.0005, or 0.001 to 0.1, 0.01, or 0.05 inch. It will be appreciated that the trench depth (the void formed of the vent) is a non-zero depth that causes a residual thickness or remaining thickness of the material at the vent to be less than a full thickness of the cell housing around the vent that does not form a part of the vent/trench.

In accordance with some non-limiting examples, the vents may be selected to open at a specific pressure value to ensure that the opening of the vent occurs prior to a burst or other opening at another location on the cell housing. That is, the vent may be configured to burst at a specific pressure to ensure that collection, direction, and control of venting gasses can be achieved. In accordance with some embodiments, the ranges of pressures that may be of interest for the vents may be within the range of 10-1,000 psi, 20-500 psi, 40-300 psi (e.g., 40 kPa to 10 MPa or subsets thereof), and/or at some value less than a rupture pressure of any other parts of the cell/cell housing (e.g., at seams, flanges, etc.). As a result, the vents are configured to open at a pressure value that is selected to prevent undesirable venting at other locations of the cell. As such, the depth, shape, etching, or other features of the vents may be selected and formed to burst or open at a desired pressure level within the cell housing.

In some embodiments of the present disclosure, the cell housing 202 and the vent 226 may be formed from or comprise the same material. In some embodiments, the cell housing 202 and the vent 226 may comprise a single component and comprise the same material, designed to open at a selected pressure. However, in some embodiments, the vent may be formed of a separate or different material (or the same material) as that of the cell housing 202 and may be attached at a location (e.g., on the slanted housing sidewall 224) on the cell housing 202. Although the vent 226 is shown opposite the terminals 204, in other configurations, the vent, and any associated slanted housing sidewall, may be arranged or positioned at any location around the perimeter or periphery of the cell housing 202 (e.g., along a side, at one or both ends, adjacent the terminals, etc.). Further, the vents described herein are not required to be arranged on slanted sidewalls, but could be placed on vertical sidewalls as well, without departing from the scope of the present disclosure.

The vent 226 may be arranged such that when internal pressure builds within the cell cavity 210, such as due to increased temperature within the electrode stack 212, the vent 226 will open and allow gases to be expelled from the cell cavity 210. In some embodiments, the vent 226 may be arranged to open in a single direction such that the material of the vent 226 in combination with the orientation and arrangement of the slanted housing sidewall 224 may direct and control expelled gases away from undesirable locations and in an intended direction. For example, the vent 226 may be located and coordinated with battery design features to ensure that expelled hot gases are not directed onto or into sensitive areas of a cell assembly and/or electronics arranged proximate the cell 200. Furthermore, in some embodiments, a cell housing may be configured with multiple vents, such as a vent on each side of the cell housing.

Although shown and described in FIGS. 2A-2C with substantially planar surfaces for the portions 206, 208 of the cell housing 202, such geometries and shapes of the cell housing are not to be limiting. For example, one or both of the portions 206, 208 may include rounded or domed shape to provide for a rounded cell (e.g., cylindrical or partially cylindrical with a flat side or portion). Accordingly, the illustrative geometries are merely provided for example and explanatory purposes and are not intended to be limiting. In some embodiments, the cell housing 202 may have a defined thickness in a direction between the first portion 206 and the second portion 208 (e.g., normal to the planar shape of the portions 206, 208). In some non-limiting embodiments, the thickness of the cell housing 202 (and thus the cell 200) may be 0.5 inch or less, providing for a thin or small cell.

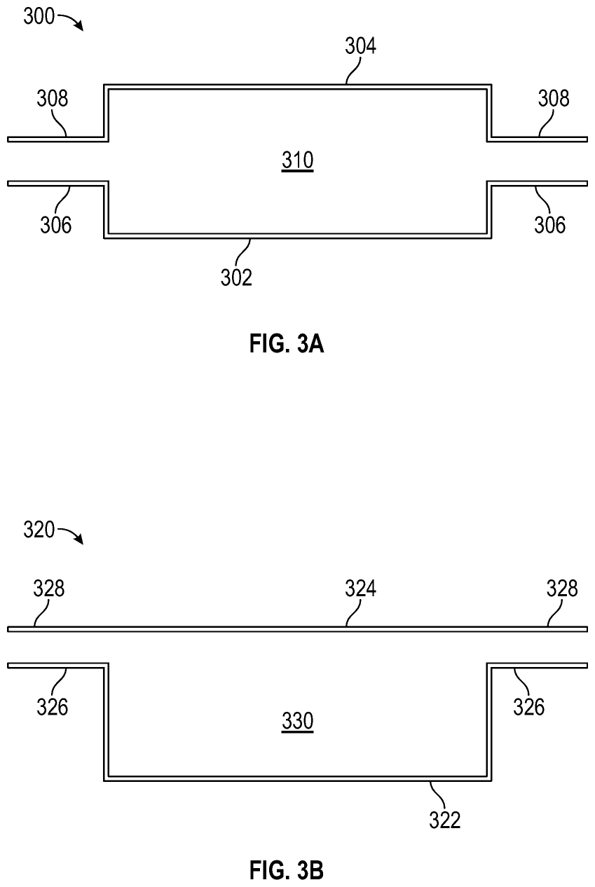

Referring to FIG. 3A, a schematic cross-sectional illustration of a cell housing 300 in accordance with an embodiment of the present disclosure is shown. The cell housing 300 includes a first portion 302 and a second portion 304. In this illustrative embodiment, the first portion 302 and the second portion 304 form a clam-shell configuration. In such a configuration, the first portion 302 includes a respective first flange 306 and the second portion 304 includes a respective second flange 308. The first flange 306 may be provided around a periphery of the first portion 302 (e.g., three sides as shown, for example, in FIGS. 2A-2C), leaving an open end for a terminal block to be engaged with tabs of a cell. Similarly, the second flange 308 may be provided around a periphery of the second portion 304 leaving an open end for a terminal block to be engaged with tabs of a cell. The joined first and second portions 302, 304 will define a cell cavity 310 therein.

Referring to FIG. 3B, a schematic cross-sectional illustration of a cell housing 320 in accordance with an embodiment of the present disclosure is shown. The cell housing 320 includes a first portion 322 and a second portion 324. In this illustrative embodiment, the first portion 322 and the second portion 324 form a bathtub configuration. In such a configuration, the first portion 322 includes a respective first flange 326. In this embodiment, the second portion 324 is a substantially flat sheet having or defining a respective second flange 328. The first flange 326 may be provided around a periphery of the first portion 322 (e.g., three sides as shown, for example, in FIGS. 2A-2C), leaving an open end for a terminal block to be engaged with tabs of a cell. The joined first and second portions 322, 324 will define a cell cavity 330 therein.

In either configuration shown in FIGS. 3A-3B, the flanges may be arranged around or along the periphery of the cell housing. The flanges may span the full periphery (e.g., four sides of a square or rectangle, full circumference of a circle, etc.) or of less than the full periphery. In some embodiments, the flanges may be provided along the side with the terminals. In other embodiments, the terminals may be arranged at a side that does not include a flange. Further, in some embodiments, only one side or a portion of the periphery includes a flange. When joining the portions of the cell housings, the flanges of the portions of the cell housings may be welded or otherwise joined together. In some configurations, ultrasonic or laser beam welding may be employed. The flanges, in accordance with embodiments of the present disclosure, can facilitate such welding and minimize or prevent heat of the welding process from reaching the cells arranged within the cell cavities during assembly. In addition to, or alternatively, the flanges disclosed herein can enable crimping of the two portions together, with or without adhesives. As such, mechanical connection, rather than welding, may be employed to join the portions and form the cell housing.

Because of the use of welding with the flanges is away from the cells, relatively thin material may be employed for the cell housings in accordance with embodiments of the present disclosure. For example, in one non limiting example, the material thickness of the first and second portions of the cell housings may be between 0.080 inch and 0.001 inch. In some embodiments, the material thickness may be 0.008 inches or less. Furthermore, in some embodiments, the width of the flanges (in an extent or direction outward from the respective aspects defining the cell cavity) may be of suitable dimensions, such as between 0.001 inches and 1 inch. In some embodiments, the width of the flanges may be 0.5 inch or less. It will be appreciated that the flanges may have any suitable dimensions and such dimensions may be selected for, for example, the ability to weld, crimp, adhesively seal, and the like. Further the flange material thickness may be selected for strength and may be varied along a length of the flange to provide increased strength at specific desired locations. The specific type of joining of the portions along the flanges may be selected to enable a desired rupture face to aid in venting of the cells in the event of overheating. For example, a welding amount may be selected to define a rupture face (e.g., by penetration or width of weld). Further, although shown in FIGS. 3A-3B as a horizontal flange, it will be appreciated that the flanges may be angled relative to the surfaces of the formed cell housing. Such angled flanges may help in providing a desired sealing between the different portions of the cell housing.

In addition to enabling welding or other joining of portions of a cell housing, in some embodiments, the flanges may be configured to aid in heat dissipation from a cell arranged within a cell housing. As noted above, the cell housings may be formed of aluminum. The use of aluminum, or an aluminum alloy, provides for improved thermal management (e.g., heat transfer from the cell to remove heat and/or enable heat to be provided into a cell, if such additional heat is desirable). The flange or any part of the flange can operate as a heat transfer fins or surfaces, thus improving heat transfer to and/or from the cell housing. In some embodiments, the cell housing may be formed from aluminum, stainless steel, or a polymer, for example. Additional thermal conductance can be provided on the outside of the cell housing, such as through the inclusion of heat pipes (e.g., flat heat pipes) and/or through arranged materials, such as copper, aluminum, pyrolytic graphite, graphene, diamond, or the like. In some embodiments, a thermal cap or epoxy layer may be applied over or on the flange(s) to electrically isolate the flanges. In some embodiments, the flange or any part of the flange can operate as a thermal fin for heat transfer to and/or from the cell in a plane of the housing/flange.

By employing a two-part cell housing, some embodiments of the present disclosure may avoid complex geometries or openings to be provided for installation of the cell within the cell housing. Furthermore, because of the two-part assembly cell housing, complex or unique shapes and geometries may be used that are not limited by the installation opening. As such, the shape, size, and geometry of the cell housing may be desirable for other considerations, such as, for example, heat dissipation, heat supply, pressure build-up considerations, installation in unique or non-uniform frames and locations, among other considerations. In other configurations, complex geometries may be employed without departing from the scope of the present disclosure. For example, as noted above and without limitation, rounded or cylindrical type geometries may be employed.

Turning now to FIG. 4A, a schematic illustration of a cell 400 in accordance with an embodiment of the present disclosure is shown. The cell 400 includes a cell housing 402 having a first portion 404 and a second portion 406 that are welded together at a flange 408. Installed within the cell housing 402 is an electrode stack 410. The electrode stack 410 includes positive electrodes 410A and negative electrodes 410B with separators 410C arranged therebetween. The first portion 404 of the cell housing 402 includes slanted housing sidewalls 412 on two sides, in this view. Each slanted housing sidewalls 412 may include one or more vents, similar to that shown and described herein. Due to the slant of the slanted housing sidewalls 412 and the geometric shape of the electrode stack 410, one or more pockets 414 may be provided around the periphery of the electrode stack 410. The pockets 414 can increasing a gas accumulation capacity of the cell 400. If a vent is provided on one of the slanted housing sidewalls 412, gas that accumulates within the respective pocket 414 may be vented therethrough. In some embodiments, different pockets of the cell may be kept substantially fluidly separate from each other, and in other embodiments, the various pockets may form a single pocket around a periphery of the cell within the cell housing. In some embodiments, the fluidly separate pockets may be on opposite sides of the cell or may be arranged along a single side of the cell.

In some embodiments, and as shown in FIG. 4A, the cell 400 can include one or more interior housing insulator elements 416, arranged on one or more sides of the electrode stack 410. In some embodiments, the interior housing insulator element 416 may be configured to reduce the need for or permit elimination of an insulator to be arranged between cell units in an assembled submodule or stack of cell units, such as described below (e.g., may eliminate thermal insulator element 1010 or insulator element 1212). In some embodiments, the interior housing insulator element 416 may provide sufficient thermal insulation to reduce the need for or permit elimination of additional thermal insulators to be employed. Such configuration may enable more universal application and ease of manufacturing. As shown, in this embodiment, only the first portion 404 of the cell housing 402 includes the interior housing insulator element 416. In other embodiments, both the first and second portions of the cell housing may include one or more interior housing insulator elements 416. The interior housing insulator element 416 may be configured for electrical insulating and for thermal insulation properties as well. The interior housing insulator elements 416 may be formed from, a polyolefin, for example, polyester or polyethylene, or a fluorinated polyolefin, or a copolymer thereof, or a tape formed thereof. In some embodiments, ethylene-tetrafluoroethylene may be employed.

Turning to FIG. 4B, an alternative configuration of a cell 450 in accordance with an embodiment of the present disclosure is shown. The cell 450 includes a cell housing 452 having a first portion 454 and a second portion 456 that are welded together at a flange 458. Installed within the cell housing 452 is an electrode stack 460. The electrode stack 460 includes electrode groups 462 with separators 464 arranged therebetween. The separators 464 can each comprise a thermal conductor layer 466 and/or a thermal insulator layer 468. The electrode groups 462 may be electrically connected in parallel or series within the cell housing 452. Each of the electrode groups 462 may be, optionally, individually contained in a separate polymer pouch, for example. The alternating thermal conductor layer 466 and thermal insulator layer 468 are placed between the electrode groups 462. The thermal conductor layer 466 may be thermally connected to or otherwise in contact with the cell housing 452, as a means to distribute heat. In other configurations, the thermal conductor layer 466 may be connected to either a cell positive terminal, a cell negative terminal, or a neutral feedthrough placed specifically for heat collection and removal, as will be appreciated by those of skill in the art. The thicknesses of the intracell conductors and insulators (layers 466, 468) may be, in some embodiments and in some examples, in the same range of those of the intercell parts described herein. The cell 450 may include slanted housing sidewalls on two sides which may include one or more vents. Due to the slant of the slanted housing sidewalls, similar to that shown and described in FIG. 4A, and the geometric shape of the electrode groups 462 and layers 466, 468, one or more pockets may be provided around the periphery of the electrode stack 460.

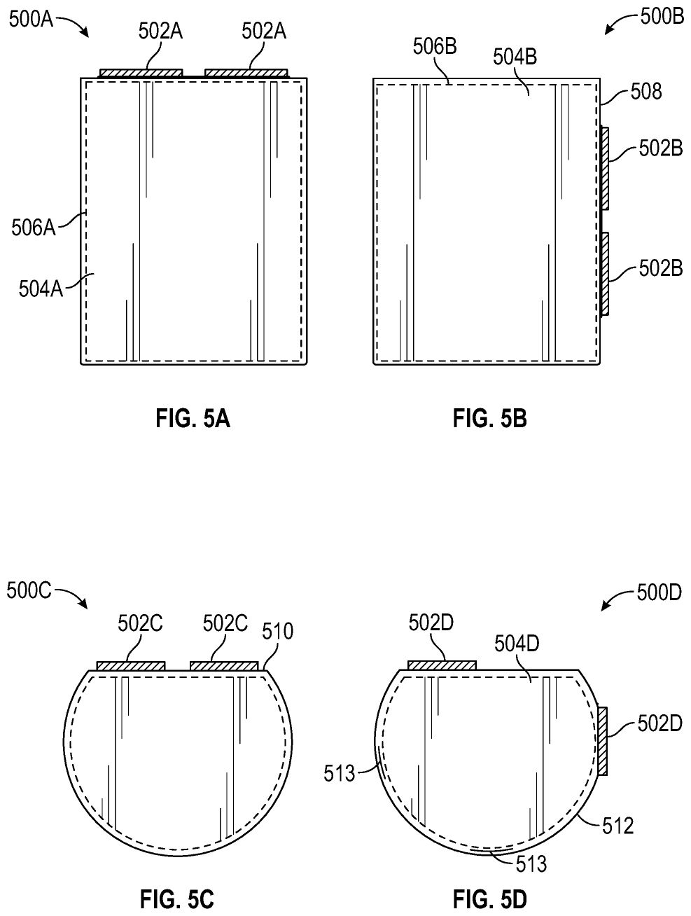

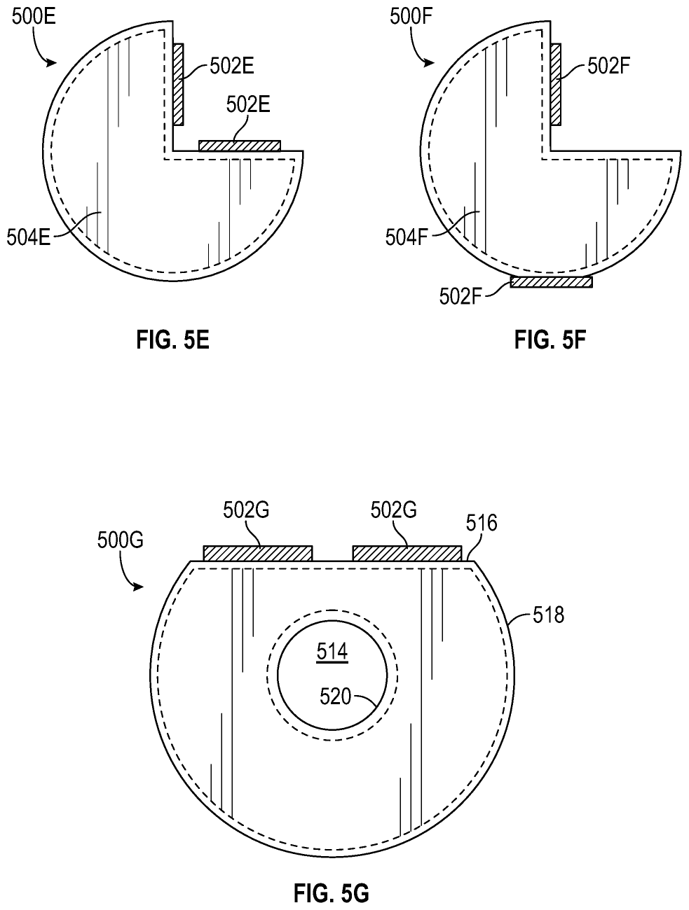

Although shown and described above with respect to substantially rectangular cells, such geometry is not to be limiting. For example, referring now to FIGS. 5A-5G, schematic illustrations of different geometric shapes of cells in accordance with embodiments of the present disclosure are shown. It will be appreciated that the disclosed example geometries and/or shapes of prismatic shaped cells that include substantially planar orientations of electrodes within the disclosed housings are not to be limiting and other geometries/shapes may be used without departing from the scope of the present disclosure. Further, it will be appreciated that in the illustrative embodiments of FIGS. 5A-5G, no specific flange is included. That is, in accordance with embodiments of the present disclosure, the above described flange may be optional or not included, depending, for example, upon the manufacturing and/or assembly of the cells. In such embodiments, the cell housings will still include a vent to enable venting of pressure/gas from an interior of the cell, as described above.

FIG. 5A illustrates a rectangular cell 500A with flat or straight side walls. The cell 500A includes terminals 502A extending from a cell housing 504A. An electrode stack 506A is disposed within the cell housing 504A and has substantially the same shape as the cell housing 504A. In this configuration, the terminals 502A extend from a short side 508 of the rectangular geometry of the cell housing 504A.

FIG. 5B illustrates a rectangular cell 500B with flat or straight side walls. The cell 500B includes terminals 502B extending from a cell housing 504B with an electrode stack 506B disposed within the cell housing 504B. The electrode stack 506B has a substantially similar shape as the cell housing 504B. The terminals 504B, in this configuration, extend from a long side 508 of the rectangular geometry of the cell housing 504B.

FIG. 5C illustrates a substantially circular or round cell 500C. The cell 500C includes terminals 502C that extend from a flat end 510 of a cell housing 504C. An electrode stack 506C is disposed within the cell housing 504C and has substantially the same shape as the cell housing 504C. In contrast, FIG. 5D illustrates a similar geometrically shaped cell housing 504D of a rounded cell 500D, but one of the terminals 502D extends from a rounded portion or rounded sidewall 512 of the cell housing 504D. In the configuration of FIG. 5D, the cell 500D includes vents 513 which are arranged on a slanted sidewall of the cell housing 504D. It will be appreciated that any of the embodiments/configurations of FIGS. 5A-5G may include a vent on a slanted sidewall of the cell housings, and thus other vents are omitted from illustration for simplicity. The placement and orientation of the vents may be selected to ensure that expelled gases are directed away from the cell in the event of an opening of the vent of the cell. As such, regardless of the geometry or shape of the cell, the inclusion of one or more vents may be provided to ensure control and direction of vented gases relative to the cell.

FIGS. 5E-5F illustrate cells 500E, 500F having a partial circular shape with terminals 502E, 502F arranged at different positions on flat or rounded edges/sides of the respective cell housings 504E, 504F.

FIG. 5G illustrates a cell 500G having an annular or torus shape with a central aperture 514. In this illustration, terminals 502G extend from a flat sidewall 516 but could be configured to extend from an exterior rounded sidewall 518 and/or an interior rounded sidewall 520.

Although a limited number of different geometric shapes and arrangements are illustrated and described with respect to FIGS. 5A-5G, those of skill in the art will appreciate that other shapes and configurations may be employed without departing from the scope of the present disclosure. Further, in each of the illustrative configurations, or variations thereon, it will be appreciated that a flange and/or slanted sidewalls and/or vent(s) may be included on the cell, as described herein.

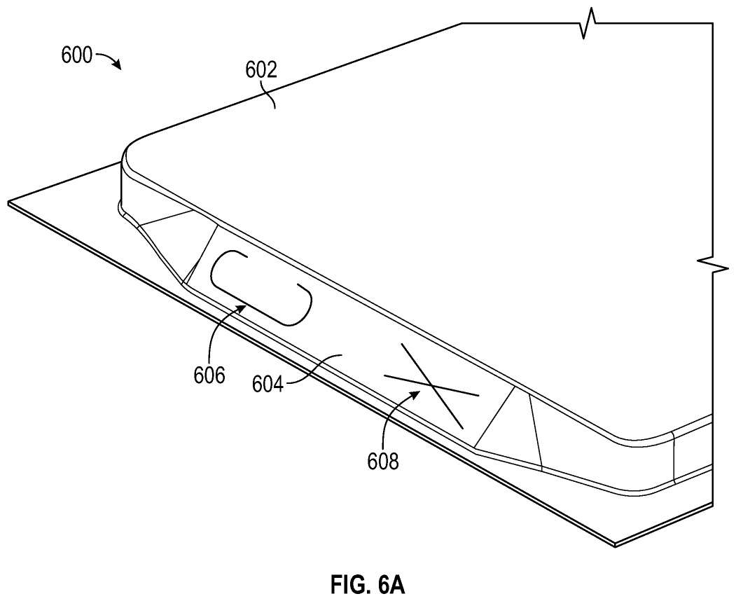

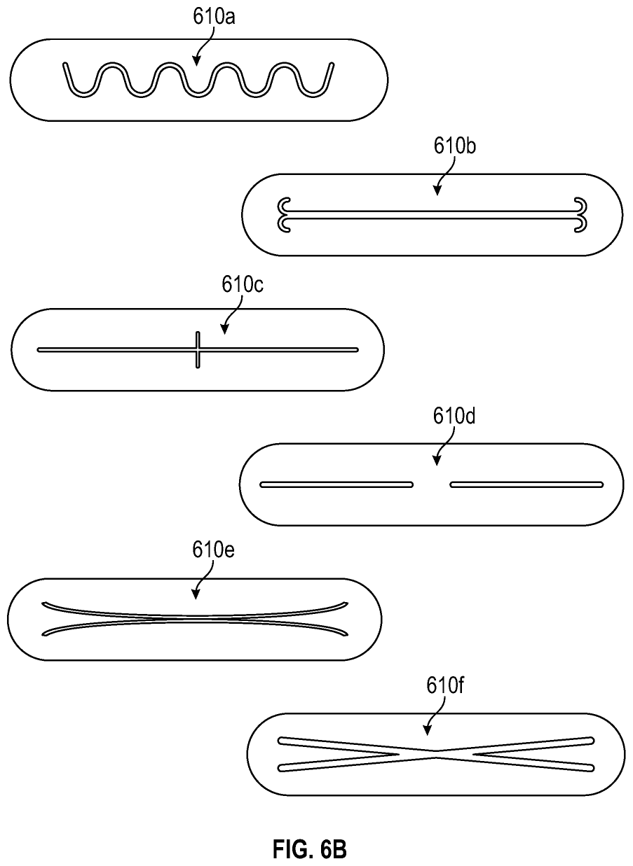

Turning now to FIG. 6A, a schematic illustration of cell 600 in accordance with an embodiment of the present disclosure is shown. The cell 600 includes a cell housing 602 having at least one slanted housing sidewall 604. In this illustrative configuration, the cell housing 602 includes a first vent 606 and a second vent 608, both arranged on the slanted housing sidewall 604. As shown, the illustrated first vent 606 has a substantially oval or racetrack geometry. The illustrated second vent 608 has a substantially X-shaped geometry. The vents may be formed by etching into the material of the cell housing 602. Such etching can provide a weakened location or area that may break or open upon pressure build-up within a cavity defined within the cell housing 602. It will be appreciated by those of skill in the art, in view of the teachings herein, that vents of the present disclose may be rectilinear, curvilinear, circular, or have other geometries, without departing from the scope of the present disclosure. For example, alternative geometries of vents in accordance with embodiments of the present disclosure are shown in FIG. 6B.

FIG. 6B illustrates different example vent configurations 610a-610f. The different vent configurations 610a-610f may be selected to achieve a venting at a predetermined pressure limit. That is, when a pressure within a cell housing reaches or exceeds a predetermined limit, the vent will burst and allow gas and pressure to be vented from the cell housing. The geometric shapes of the various vent configurations 610a-610f may be formed by etching, machining, coining, stamping, or the like. The vent configurations 610a-610f define shapes of reduced material thickness as compared to the material thickness around the respective vent configurations 610a-610f. This reduced material thickness provides for a weak or less rigid section that can burst when reaching the pressure limit and thus allow venting from the cell housing. It will be appreciated by those of skill in the art that other geometric shapes and profiles may be used. Further, multiple similar or difference vent configurations can be employed on a single cell housing, as desired for a particular application.

Although FIGS. 6A-6B illustrate a limited number of example geometries, it will be appreciated by those of skill in the art that other geometries for the vents may be employed without departing from the scope of the present disclosure. For example, various wave or wave-type shapes and/or lines may be formed in the material of the housing to function as one or more vents. The wave-type shapes/lines may be described as curvilinear, having one, two, three, four, five, or more peaks/troughs along the vent shape. Moreover, a straight line or a line with hash marks, etc., may be employed. As such, it will be appreciated that many different geometries of vents may be employed without departing from the scope of the present disclosure. Further, it will be appreciated that multiple vents may be incorporated into the cell housing and may be located at maxima of strain caused by pressure rise. It will be appreciated that multiple similar or different geometry vents may be arranged at multiple different locations about the periphery or edges and surfaces of the cell housings. If multiple vents are employed the different vents may have different venting set points such that the vents may rupture to vent the interior at different pressure levels.

In some embodiments, the vent may be integrated into the slanted sidewall construction and is not required to be etched. For example, the slant feature may create a stress concentrator to allow the cell to vent in a preferred venting direction (e.g., at the bottom of the cell) without the need for etching. In some configurations such venting enabled by the angled or slanted sidewalls may be in addition to or redundant with an etched vent feature. The slanted sidewalls will create additional surface area against which pressure can act and thus allow for larger and more manufacturable vent(s) as compared to a vertical or straight sidewall (i.e., non-slanted). In accordance with some embodiments, the vents can be integral and etched or attached (e.g., weld, crimp, adhesive, etc.) of a separate part that may be of the same or different materials than the rest of the cell housing. For example, in one non-limiting embodiment, a vent may be formed of nickel which has a preferred elongation-to-rupture value and thus vents at a lower pressure compared to the rest of the cell housing (e.g., made of aluminum).

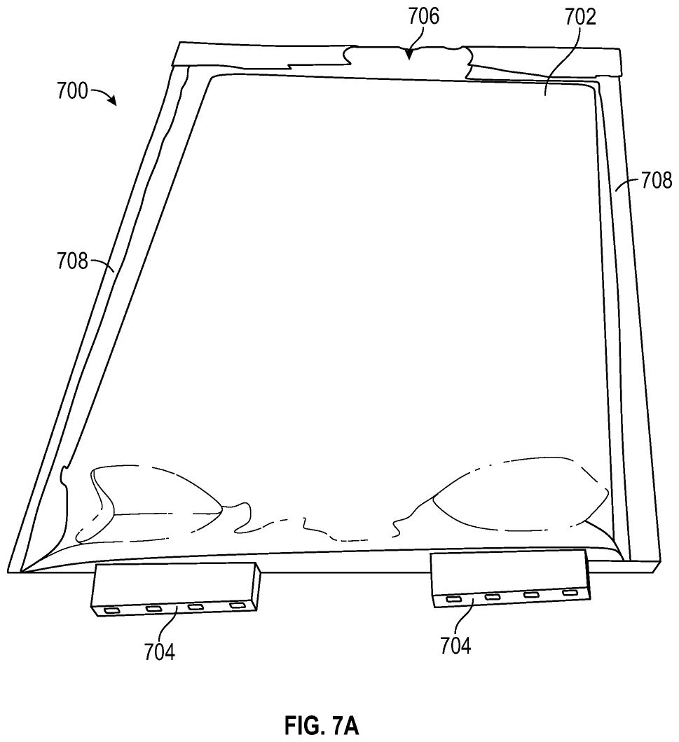

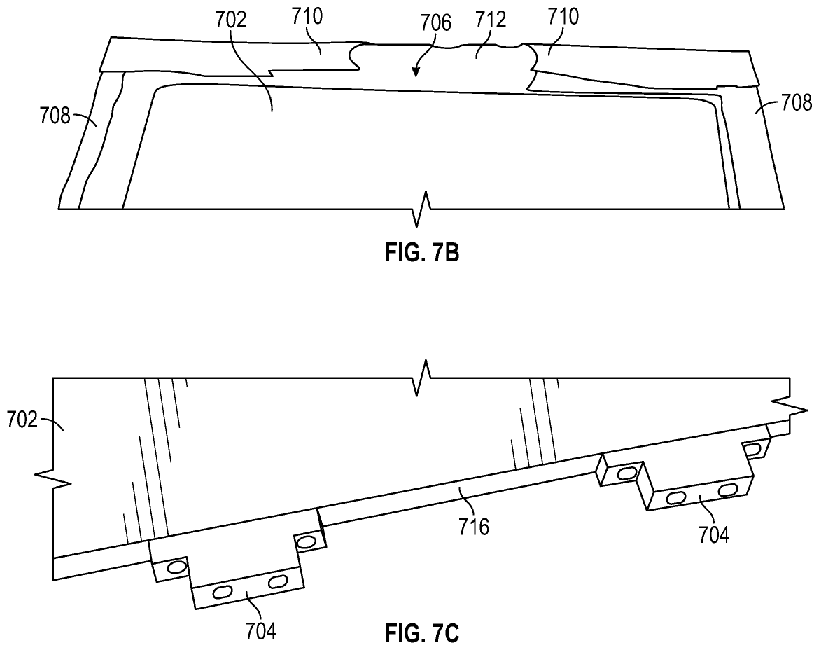

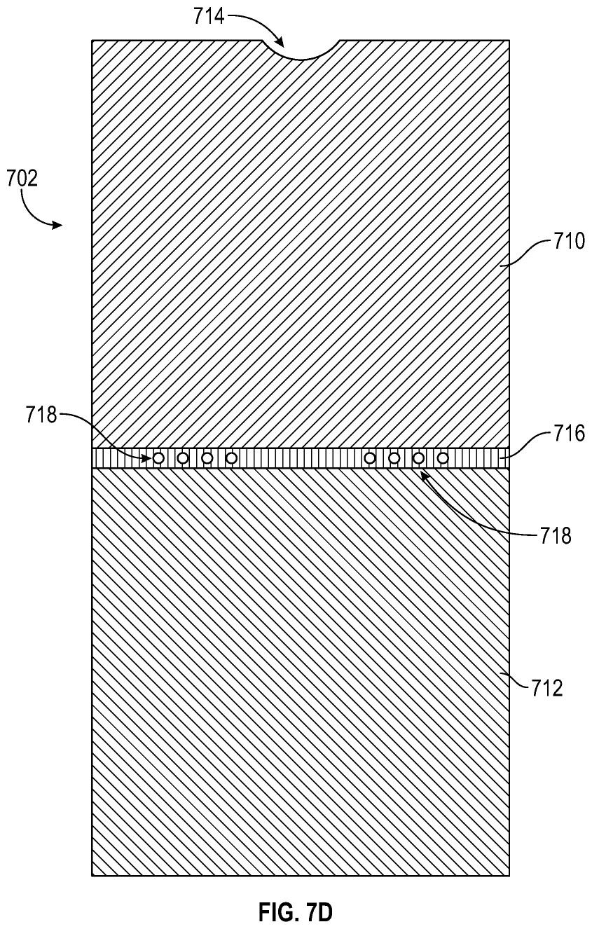

Turning now to FIGS. 7A-7D, schematic illustrations of a cell 700 for use in a battery in accordance with an embodiment of the present disclosure are shown. The cell in this embodiment includes a positive electrode (e.g., a cathode) and a negative electrode (e.g., an anode), with separators therebetween, arranged within a pouch 702. In some embodiments, the cell 700 may comprise a plurality of positive electrodes and a plurality of negative electrodes to provide an electrode stack. In other embodiments, a single positive electrode and a single negative electrode may be employed. The pouch 702 may be configured to be installed within a cell housing, for example, similar to that shown and described herein. The pouch 702 may be formed of one or more sheets of material (e.g., metallized foil) which may be folded or wrapped about the electrodes to form the electrochemical portion of the cell 700.

The cell 700 includes terminals 704 extending out an end of the pouch 702. Opposite the terminals 704 is a vent 706. The material of the pouch 702 may be crimped, bonded, heat sealed, or otherwise sealed around a periphery 708 thereof. At the end of the pouch 702 having the vent 706, a first side 710 of the pouch 702 may be folded over a second side of the pouch 712 and a recess 714 in the first side 710 defines and forms the vent 706 when joined or bonded together. The vent 706 may be structurally formed as a gap or lightly welded or bonded section of the pouch that will burst prior to the rest of the pouch if a pressure within the pouch increases to an undesirable level. However, such mechanical vents are not required with the pouch configuration. For example, etching as described above may be employed, including at locations where folds of material overlap at seams or the like.

FIG. 7D illustrates the material or sheet of the pouch 702 prior to encasing the sheets of material of the cell 700. As shown, the material or sheet of the pouch 702 includes a midsection 716 that is between the first side 710 and the second side 712 thereof. The midsection 716 includes terminal apertures 718 configured to enable electrical connection between the terminals 704 and the sheets of material contained within the pouch 702. The midsection 716 provides for a continuous material around the end of the cell 700 having the terminals 704.

The pouch 702 may comprise any suitable metallized film (e.g., an aluminum coated polyester film). In some configurations that use non-metallic materials, the assembled cell 700 may be sealed within a hermetic cell housing. The pouch can provide for improved cooling, in some configurations, by enabling direct or improved connection when assembled in a stack of cells in an assembly (as described herein). The pouch material can provide for improved cooling overall through cooling of busbars via a ceramic conductor interface. Because of the construction of the pouch from a single, folded sheet of material, the midsection can provide for improved strength proximate the terminals. No sealing or bonding is necessary, which can provide for weak points in the structure. The periphery 708 and the ends of the sides 710, 712 can be joined through folding of the material of the pouch 702 itself. Such folds can provide high strength while minimizing assembly steps, costs, and processes. Further, the material of the pouch 702, at least along the periphery 708, can be held between portions of a cell housing, for example, as shown and described herein. This configuration also, advantageously, can employ a built-in vent as part of the cell 700. Any such vents may be arranged on any side or sides of the cell 700 (e.g., long or short sides, terminal or opposite end, etc.). The vents on the pouch configurations may be formed or defined by varying sealing parameters or creating a mechanical weakness such as the section that is not folded over.

Because the cell 700 is formed by folding the two sides 710, 712 about the sheets of material, bends or creases in material may form during assembly. To avoid such creases and bends, which can be detrimental and form weak spots in the assembled cell, optional spacers may be arranged within the pouch. Such spacers may also operate as insulators, or alternatively, additional insulators may be arranged within the pouch. The insulators and/or spaces can have rounded corners, thus minimizing the chance of piercing or damaging the material of the pouch 702. The insulators or spacers may also be configured to keep metalized layer(s) from becoming polarized, which can lead to shorts or corrosion. Moreover, advantageously, by using a pouch configuration as illustrated in FIGS. 7A-7C, no heat is required to seal the cell around the location of the terminals. This allows for the strongest film to be in the area that is normally the weakest due to mechanical disruption and being warmer. Advantageously, this can enable a higher rate of operation.

The cells described herein may be assembled into a battery or battery assembly, where multiple cells are arranged in any suitable combination of parallel and series connections to supply a high amount of electrical power. Such cell assemblies can include any number of cells. The number of cells may be selected to achieve a desired output from the battery assembly. To mount or assemble multiple cells into a battery assembly, each cell may be first mounted into a cell frame.

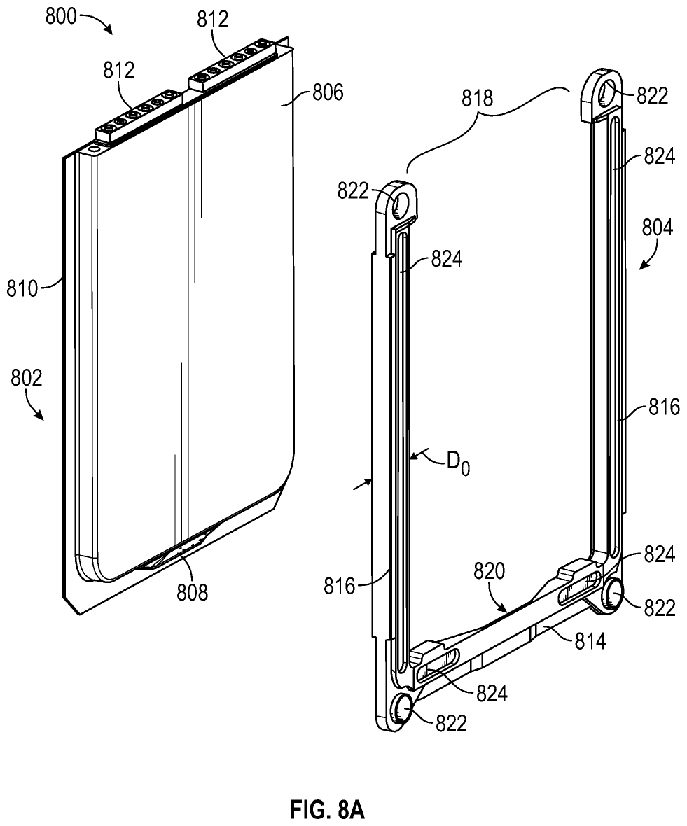

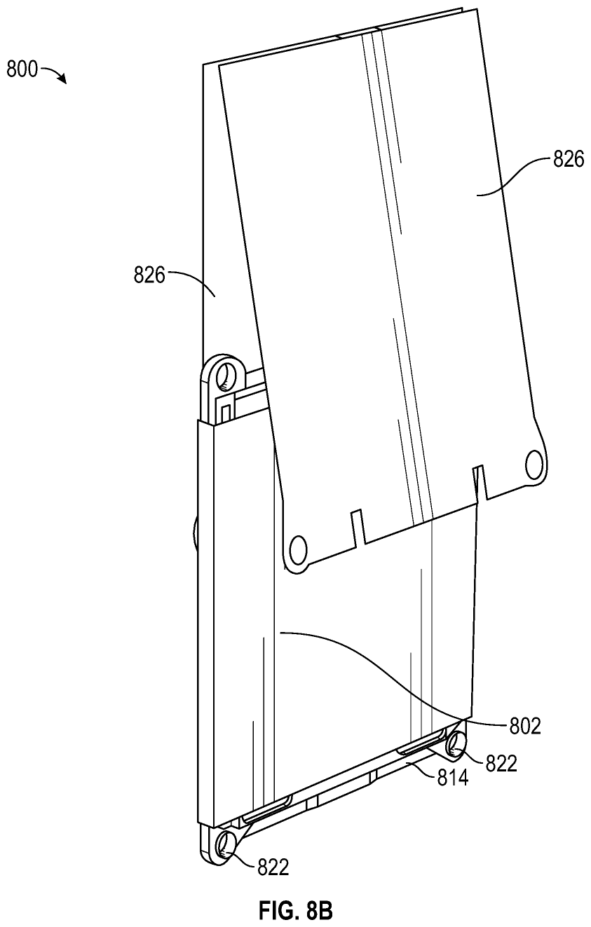

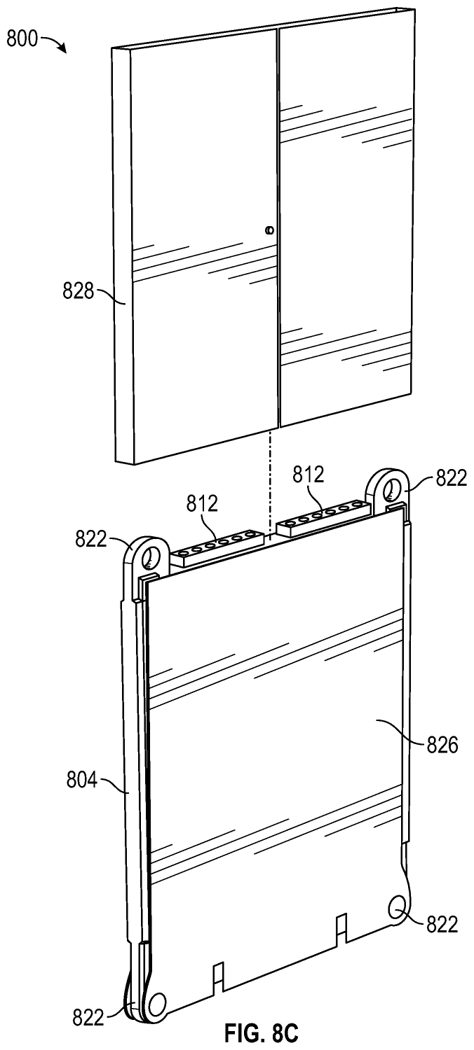

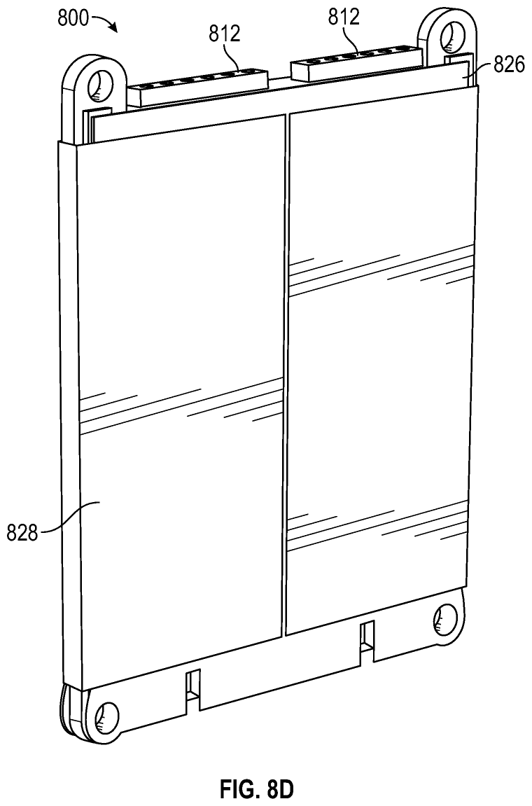

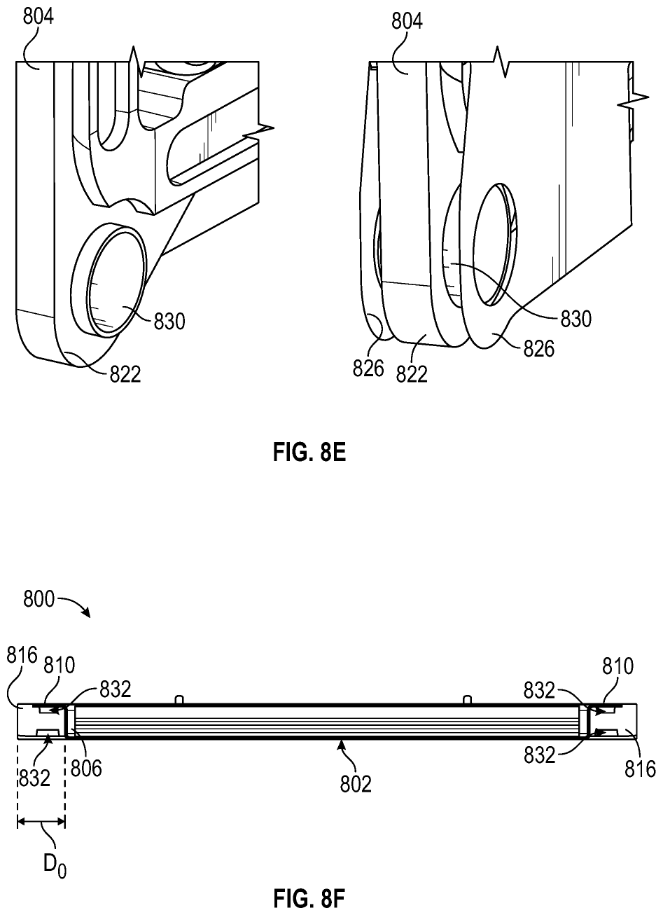

Turning now to FIGS. 8A-8F, schematic illustrations of a cell unit 800 in accordance with an embodiment of the present disclosure are shown. The cell unit 800 includes a cell 802 and a unit frame 804. The unit frame 804 is configured to receive and support the cell 802. The unit frame 804 may be configured to hold the cell 802 and provide alignment functionality relative to other similar cells 802 within similar unit frames 804. The material of the unit frame 804 may be selected to be electrically insulative while thermally insulative or conductive, depending on the needs in which the cell unit 800 will be used. The cell 802 may be similar to the cells shown and described herein (e.g., cells 100, 200, 400, 600, 700 shown above). The cell 802 includes a cell housing 806 having an optionally slanted housing sidewall 808 that includes a vent and a flange 810 around a periphery thereof. The cell 802 includes terminals 812 at an end thereof.

The unit frame 804 includes a base 814, arms 816, and an open end 818. It will be appreciated that the unit frame may be sized and shaped to accommodate a specific geometric profile of the associated cell. For example, if a rounded cell is employed, the unit frame will be structurally arranged to receive such rounded cell, and thus the rectangular nature of the presently described embodiment is not intended to be limiting, but rather for illustrative and explanatory purposes only.

The unit frame 804 may be electrically insulative, and may be thermally conductive or insulative, depending on the specification desired. The unit frame 804 is substantially open and shaped to receive the cell 802. The open end 818 is provided to receive the terminals 812 of the cell 802 and allow access thereto. As such, the open end 818 may be provided to ensure orientation of the cell 802 within the unit frame 804 and to aid in orientation and alignment of the cell unit 800 when configured in a battery module or other assembly. The base 814 includes an optional recess 820 that may be shaped to accommodate the slanted housing sidewall 808 and vent of the cell 802. The recess 820 can be shaped, oriented, and configured to guide the passage of vented gas and/or enable expansion of vented gas from the cell 802. As such, the recess 820 is configured to collect and direct gas away from the cell in the event of a leak of gas from the cell.

Corners of the unit frame 804 include mounting features 822 that are configured to enable installation of the cell unit 800 into a battery assembly with multiple cell units. Each unit frame 804 may include one or more alignment features 824, such as recesses or depressions, on a face of the base 814 and/or along the arms 816. The alignment features 824 may be configured to engage with respective tabs, protrusions, or other mating alignment features of an adjacent cell unit during assembly into a multi-cell battery assembly, such as described herein. Further, the alignment features 824 or the like may provide for anti-slip or anti-shifting functionality for two or more cells that are arranged together. In some configurations, the alignment features 824 may be configured as tabs, protrusions, hooks, ribs, guides, dovetails, etc. that interact with a recess or otherwise may be configured to engage or contact an adjacent cell. In addition to providing alignment functionality, the alignment features can also include retention or attachment functionality to both align and secure components of the cell unit together.

Referring to FIG. 8B, the cell unit 800 can include one or more cell insulators 826, which may be arranged on one or both sides of the cell 802. The cell insulators 826 may be formed of materials selected to be electrically insulative and may be thermally conductive (i.e., to minimize thermal resistivity and maximize dielectric properties). In some embodiments, the cell insulators 826 may be part of an outer layer of a polymer pouch (e.g., with the cell 700 of FIGS. 7A-7D). The cell insulators 826 may be electrically insulating components that are arranged on one or both sides of the cell 802. The cell insulators 826 may comprise a sheet-type structure that may be held in place by the mounting features 822 on the unit frame 804. In some embodiments, the cell insulators 826 may be a single sheet that folds over the cell 802 and may cover both sides of the cell 802 using a single, folded cell insulator 826. The cell insulators 826 may be made, for example and without limitation, from polyimide film or other electrical insulating material (e.g., polyimide or polyester). The cell insulators 826 may be arranged as single layers of material. The layers may be single-sided or double-sided (e.g., an adhesive on one or both sides), and may be configured with or without coverage of the recess, described herein, that is provided for defining a vent gas path. The cell insulators 826 may be applied by adhesive or a single wrap structure applied about the cell 802.

In one non-limiting example, the cell insulators 826 are provided for configurations in which the cell housing is formed from an electrically conductive material (although such housings can be formed form neutral materials). Further, such cell insulators 826 may be employed with cell housings formed from neutral materials. The polyimide material may be of suitable dimensions, such as below 0.010 inch, or in some embodiments, between 0.003 inch and 0.005 inch. It will be appreciated that the cell insulators 826 may be configured, based on material selection and/or size/dimensions, to be electrically insulative to maximize dielectric strength and thermally conductive to minimize thermal resistivity. The cell insulators 826 may be selected and configured to result in an anisotropic thermal conductivity distribution. In other embodiments, the cell insulators 826 may be formed from a pyrolytic graphite and/or graphene that is coated with polyimide. The arrangement of the cell insulators 826 on the cell 802 is to provide a cover of the cell face and the area around the terminals 812 to eliminate exposed metal. In some embodiments, the cell insulators 826 may be attached to the cell 802 by means of an optional adhesive. The cell insulators 826 may also be of sufficient dimension to overlap and align with the vent of the cell 802 to aid in gas management.

Referring to FIG. 8C, the cell unit 800 can include a unit wrap structure 828. The unit wrap structure 828 may be wrapped about and contain the cell 802, the unit frame 804, and the cell insulators 826, allowing for the mounting features 822 and the terminals 812 to be exposed and accessible. In accordance with some embodiments, and without limitation, the unit wrap structure 828 may comprise any suitable thermally conductive material (e.g., aluminum or an aluminum alloy). The unit wrap structure 828 may be arranged as a thermal conductor. As such, the unit wrap structure 828 may be designed to direct and move heat from a face (e.g., large flat surface of the cell housing) to the edges of the cell unit 800 (e.g., to and toward the arms 816 of the unit frame 804). The unit wrap structure 828 can be used for both cooling (e.g., heat removal) of the cells 802 of the cell unit 800 and heating (e.g., heat injection) of the cells 802. The unit wrap structure 828 may be formed from an anisotropic material (e.g., pyrolytic graphite, graphene, etc.) that can limit transfer of heat to adjacent cell units when installed in a battery assembly.

Further, the unit wrap structure 828 may be configured to be electrically conductive or electrically insulative, depending on the desired implementation and use of the cell unit 800. For example, the unit wrap structure 828 may be formed from composite materials or multiple layers, including, for example, an electrical insulator. The material thickness of the unit wrap structure 828 may be of any suitable thickness, such as, for example, between 0.001 inch and 0.040 inch. Those of skill in the art will appreciate that seams in the unit wrap structure 828 may be avoided along the faces of the cells 802 such that detrimental impacts on chemistry may be avoided. Although shown as wrapping structures, other types of thermal management may be employed without departing from the scope of the present disclosure. For example, heat pipes, cooling plates, coatings, and/or pyrolytic graphite may be employed for thermal management of the cell unit 800.

FIG. 8D illustrates the cell unit 800 as fully assembled, such as prior to installation within a battery assembly having multiple cell units. The unit wrap structure 828 may be a sheet of folded material that wraps around the other components of the cell unit 800. The unit wrap structure 828 may be formed from a thermally conductive material, thus enabling heat transfer to or from the cell unit 800.

FIG. 8E illustrates an enlarged illustration of the mounting features 822 and the cell insulators 826. In this embodiment and as shown, each mounting feature 822 includes a boss 830. The boss 830 defines a through-hole for engagement into and installation within a battery module, as described herein. The boss 830 also extends outward from the material of the unit frame 804. This extension of the boss 830 enables installation and retention of the cell insulator 826. Accordingly, in some embodiments, the cell insulators 826 may be installed to the unit frames 804 and the cell unit therein, to avoid use of tape, adhesive, or other mechanism for attaching the cell insulator 826 within the cell unit 800. The mounting features 822 and/or the bosses 830 may be configured to aid in and/or allow stacking and alignment of adjacent cells. In some configurations, a radius of the boss(es) may be selected to minimize stack binding. Although shown as a boss configuration, other configurations of mounting features may be employed without departing from the scope of the present disclosure. For example, a radiused configuration (no extending boss), a radius and boss configuration, interlocking bosses, or the like may be employed without departing from the scope of the present disclosure.

Referring now to FIG. 8F, a cross section schematic illustration of the cell unit 800 is shown. As shown in FIG. 8F, the arms 816 of the unit frame 804 include one or more air gaps 832. The air gaps 832 may be an optional feature that can reduce weight and provide for reduced thermal conductivity across the arms 816 of the unit frame 804 from the cell 802. The air gaps 832, formed by channels or grooves within the arms 816 of the unit frame 804 (e.g., defined by the alignment features 824), will result in an increased thermal path length. Such increased thermal path length can delay heat transfer from one cell to an adjacent cell due to the width of the arms 816 of the unit frame 804 that define the air gaps 832. Air gaps may define a space that can be used to tighten the wrap structure so that the thermal contact resistance between the wrap structure and the cell case or electrical insulator is minimized to improve heat flow away from (or to) the cell unit. For example, when two or more cell units are stacked, compression may cause a portion of the wrap structure to depress into the air gaps and such compression may deform a portion of the wrap to provide a seal or firm contact between the adjacent cell units. This is advantageous as it can prevent or reduce the possibility of critical failures to cascade within a battery assembly (e.g., prevent a single cell failure from causing additional cell failures). In some embodiments, the alignment features 824 may be configured to provide both alignment capabilities while also defining and forming the air gaps 832, when the cell unit 800 is assembled. Additionally, the alignment features 824 may be configured to promote thermal conduction to or from the cell 802 while inhibiting thermal conduction between immediately adjacent cells and electrical conduction to or from the cell body.

As shown in FIGS. 8A, 8F, the arms 816 of the unit frame 804 may have a dimension D₀. The dimension D₀ is a direction in-plane with the cell 802 when installed within the unit frame 804. The dimension D₀ may be provided at different sizes based on an intended use or for other purposes. For example, the dimension D₀ of the unit frame 804 may be selected for support of a flange of the cell 802, to provide thermal properties (e.g., thermal isolation), or for other reasons. In such embodiments, the dimension of D₀ may be selected to provide a controlled thermal path for distributing heat away from the cell or directing heat to the cell. For example, providing a larger dimension of D₀ may increase a thermal path such that a thermal insulator between cell units may more uniformly distribute heat when multiple cell units are stacked together. In accordance with some non-limiting embodiments of the present disclosure, the dimension D₀ of the unit frame 804 may be between 0.05 inch and 0.5 inch, 0.1 inch and 0.3 inch, 0.15 inch and 0.25 inch, etc., inclusive.

In the above described cell unit 800 of FIGS. 8A-8F, the cell insulator 826 and the unit wrap structure 828 may be a preformed, clad part. It will be appreciated by those of skill in the art that any number of components of the present disclosure and description may be integrally formed as a single structure having the described features and functionalities, and the separate nature illustrated herein is not intended to be limiting, but rather is provided for illustrative and explanatory purposes only.

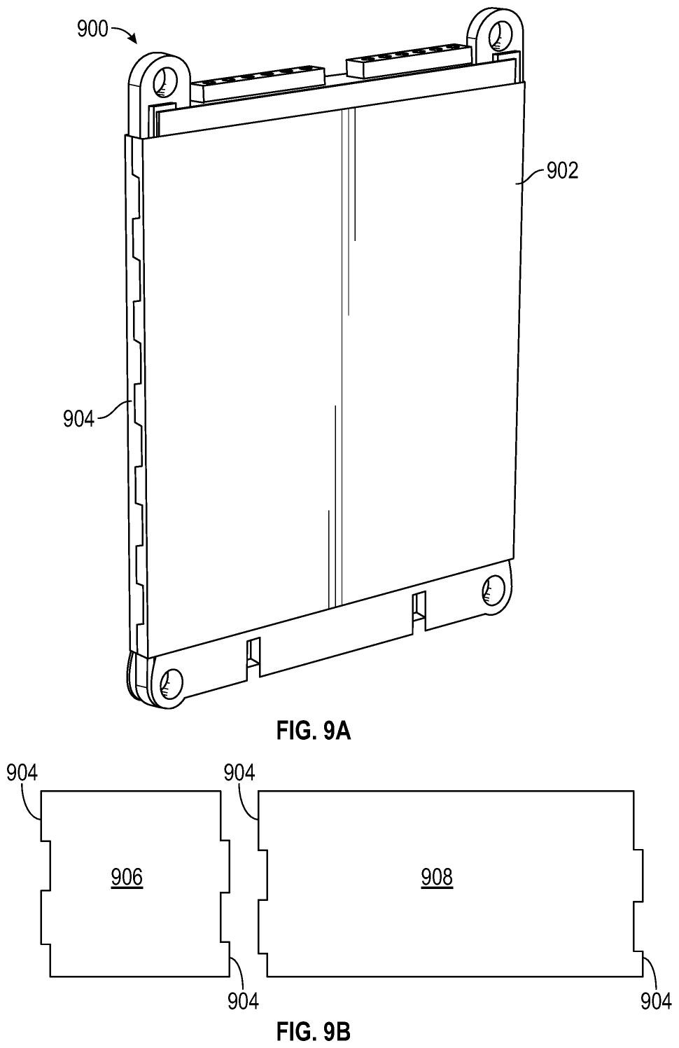

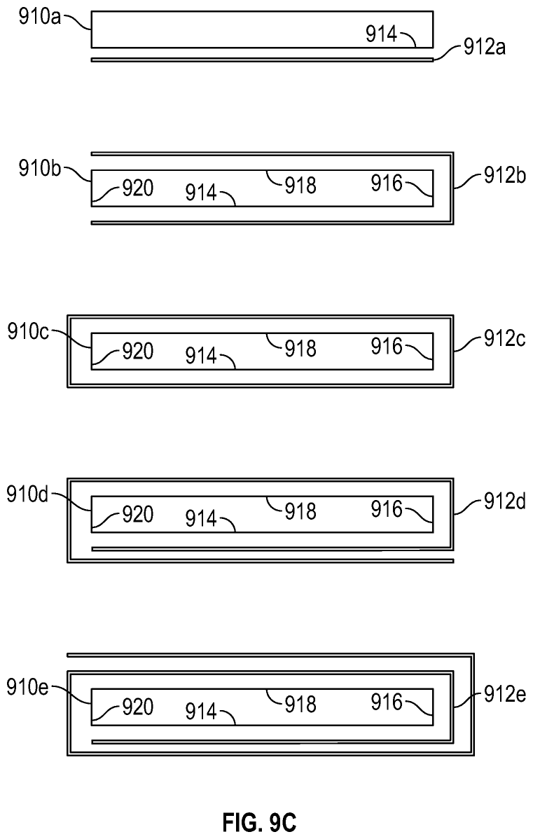

Turning now to FIGS. 9A-9C, schematic illustrations of a cell unit 900 are shown. FIG. 9A illustrates the assembled cell unit 900, FIG. 9B illustrates two example options for a unit wrap structure 902 of the cell unit 900, and FIG. 9C illustrates different configurations of wrapped cell units. As shown in this embodiment, in FIG. 9A, the unit wrap structure 902 includes a toothed geometry 904. The toothed geometry 904 may be at opposing edges of the unit wrap structure 902. In some embodiments, such as shown in FIG. 9B, two similar and matching wrap portions 906 may be used and the toothed geometry 904 would be present at two locations on the cell unit 900 (e.g., along opposing arms of the unit frame). In other embodiments, a single larger sheet or wrap 908 may be used for the unit wrap structure 902. In such embodiments, the cell unit 900 may have a single toothed structure at one location. In some embodiments, for example and without limitation, tapes, adhesives, or films may be used to secure the unit wrap structure 902 about the cell unit 900.

Referring to FIG. 9C, different configurations of unit wrap structure 912a-912e wrapped about a respective cell assembly 910a-910e are shown. The configurations shown in FIG. 9C may be representative of different embodiments and configurations of the unit wrap structure 828 shown in FIG. 8C.

In the first configuration, the unit wrap structure 912a is a single sheet of material arranged on only one major side of the cell assembly 910a. As such, the single sheet of material may be arranged to cover only one major side 914 of the cell assembly 910a.

In the second configuration, the unit wrap structure 912b is a single sheet of material arranged about two major sides 914, 918 and a minor side 916 of the cell assembly 910b but does not extend completely around the exterior of the cell assembly 910b. In this configuration, the unit wrap structure 912b covers a first major side 914, a minor side 916, and a second major side 918 of the cell assembly 910b but does not extend to cover a second minor side 920.

In the third configuration, the unit wrap structure 912c is a single sheet of material wrapped entirely about the exterior of the cell assembly 910c (e.g., a 360° wrap). In this configuration, the unit wrap structure 912c extends over a first major side 914, a first minor side 916, a second major side 618, and a second minor side 920 of the cell assembly 910c.

In the fourth configuration, the unit wrap structure 912d is a single sheet of material wrapped about the cell assembly 910d including a section of double wrapping (e.g., about 450° wrap). In this configuration, the unit wrap structure 912c extends over a first major side 914, a first minor side 916, a second major side 618, and a second minor side 920 of the cell assembly 910c, and then over the first major side 914 again.

In the fifth configuration, the unit wrap structure 912e is a single sheet of material wrapped about the cell assembly 910e including almost a complete double wrapping (e.g., about 720° wrap). In this configuration, the unit wrap structure 912c extends over a first major side 914, a first minor side 916, a second major side 618, and a second minor side 920 of the cell assembly 910c, and then over the first major side 914 again, the first minor side 916 again, and over the second major side 918 again.

It will be appreciated that the illustrations and configurations of FIG. 9C are provided as examples only. The unit wrap structures, in accordance with embodiments of the present disclosure may be arranged on a single side of a cell, wrapped around the cell once, or may be wrapped around the cell in multiple or fractional portions such that the major and minor sides of the cell assemblies may be covered multiple times. In use, the minor/short sides of the cell assemblies may be where the heat is gathered for transfer to or away from the cell. As such, the number of wraps about the major and minor sides may be selected to optimize this thermal transfer. Further, it may be desirable to have only the major or minor sides covered, leaving the other (minor or major) uncovered by the wrap structure. Thus, the specific geometry and shape of the unit wrap structures is not intended to be limited by the above description and illustrative embodiments. In some embodiments, the termination or end of the unit wrap structure may be aligned with an air gap of the unit frame. In some embodiments, an overlapping seam (e.g., end of the wrap) may extend slightly beyond a complete wrap, thus providing additional length/material that may continue to overlap with an underlying portion of the wrap. Such extension may be used to form an interfering feature that will allow the wrap unit to be tightened into a subsurface gap in the unit frame.

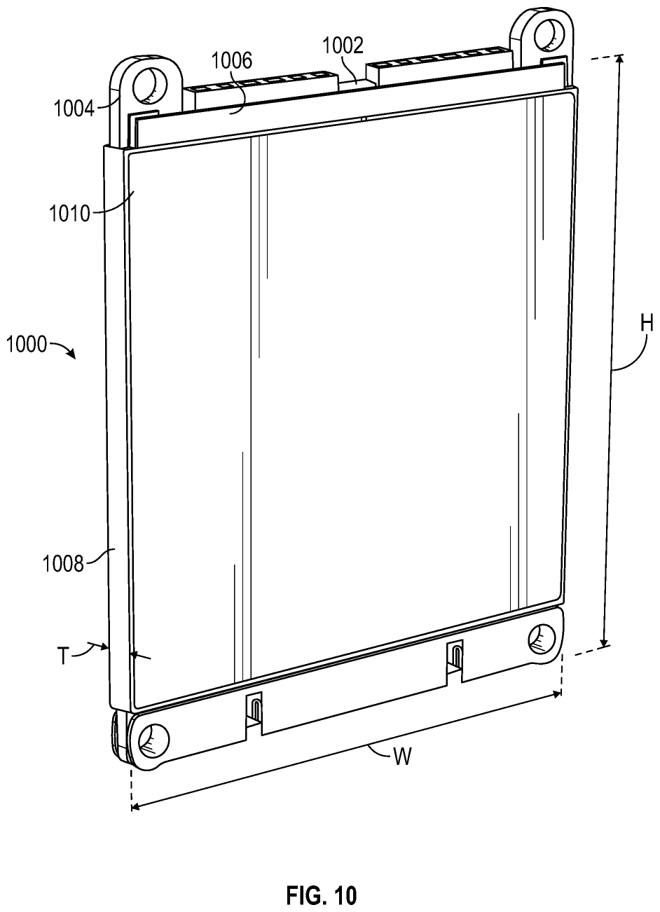

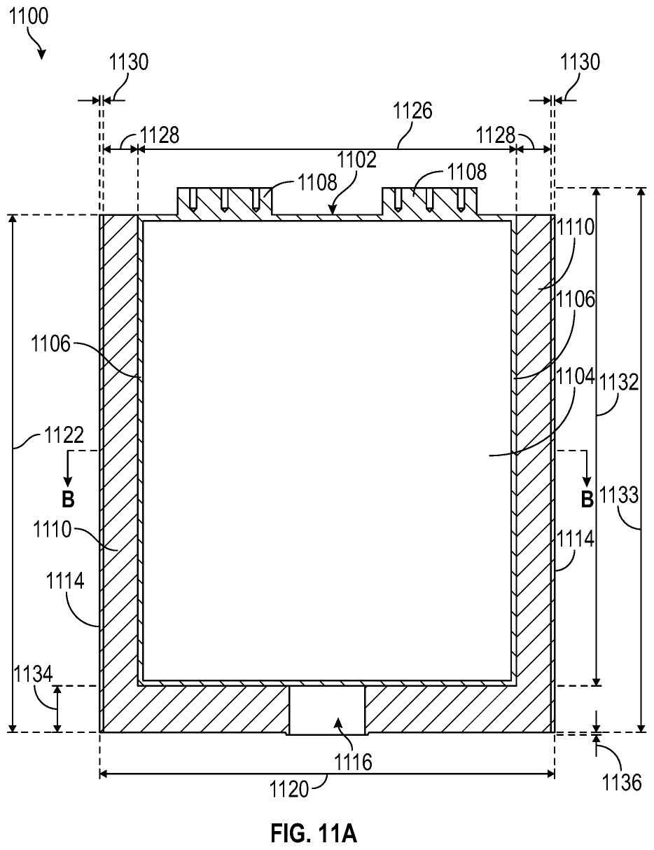

Turning now to FIG. 10, a cell unit 1000 configured to be installed within a battery module or battery assembly, in accordance with an embodiment of the present disclosure, is shown. The cell units of the present disclosure provide for improved packing efficiency, and thus allow for high efficiency battery modules and battery assemblies. As shown, the cell unit 1000 is formed substantially like the cell units shown and described above. The cell unit 1000 includes a cell 1002 arranged within a unit frame 1004. A cell insulator 1006 is arranged relative to the cell 1002 and is bounded by a unit wrap structure 1008. An insulator element 1010 is arranged on the cell unit 1000. The cell unit 1000 has a height H, a width W, and a thickness T. The height H and the width W define a plane defined by, for example, the cell insulator 1006, and the thickness T is a dimension normal to the plane defined by the height H and the width W.

In one non-limiting example of a cell unit 1000 in accordance with an embodiment of the present disclosure, in a cell case or case having a thickness of 0.4 inch, each cell insulator 1006 may have a material thickness of 0.001 inch, the unit wrap structure 1008 may have a thickness of 0.002 inch, and the insulator element 1010 installed on the cell unit 1000 may have a thickness of 0.005 inch. This yields a packing efficiency of 97.3% in the direction of the thickness T dimension. Such packing efficiency is provided relative to physical dimension and thermal conductivity path length and provides for anisotropic heat transfer (e.g., high conductivity in plane HW and very low conductivity in direction T). For example, a high conductivity in-plane may be two orders of magnitude or greater than the low conductivity in the direction T (e.g., an in-plane thermal conductivity that is 10 times to 1,000 times that of silica (0.5 W/mK), and a through-plane thermal conductivity that is 1 time to 0.01 times that of silica). In accordance with embodiments, it may be advantageous to have high heat flux in the plane HW and a low heat flux in the direction T. Heat flux is a flow of energy per unit area per unit time.

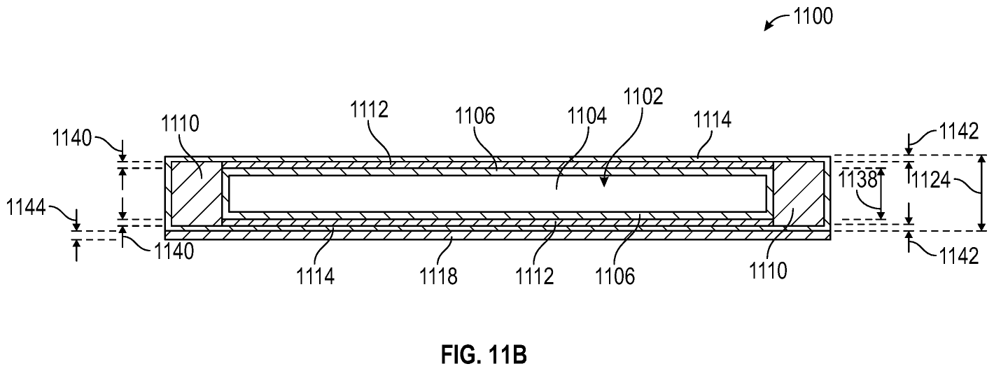

Turning now to FIGS. 11A-11B, schematic illustrations of a cell unit 1100 in accordance with an embodiment of the present disclosure are shown. FIG. 11A is a cross-sectional illustration of the cell unit 1100 and FIG. 11B is a cross-sectional view of the cell unit 1100 of FIG. 11A as viewed along the line B-B indicated in FIG. 11A.

The cell unit 1100 includes a cell 1102 having an electrode stack 1104 arranged within a cell housing 1106. The cell 1102 includes terminals 1108 (e.g., positive and negative terminals) for external electrical connections. The cell 1102 is mounted within a unit frame 1110. As shown in FIG. 11B, cell insulators 1112 are arranged on opposing sides of the cell 1102. The cell 1102, the unit frame 1110, and the cell insulators 1112 are wrapped within a unit wrap 1114. The unit frame 1110 includes a recess 1116 that is shaped to accommodate a housing sidewall and vent of the cell 1102, slanted or flat. Attached to one side of the cell unit 1100 is an insulator element 1118 that is arranged on an exterior of the unit wrap 1114.

As shown, the cell unit 1100 has a width 1120, a shoulder height 1122 (excluding the terminals 1108), a total height 1133, and a thickness 1124 (excluding the insulator element 1118). In one non-limiting example, the width 1120 of the cell unit 1100 may be 6.082 inch, the height 1122 of the cell unit 1100 may be 6.045 inch, and the thickness 1124 of the cell unit 1100 may be 0.404 inch. These measurements/dimensions, and the following measurements/dimensions, are merely provided for explanatory and illustrative purposes and are not intended to be limiting in any way. As will be appreciated by those of skill in the art, the dimensions and relative dimensions of the various aspects of the cell units and other components may be set based on desired properties, considerations related to weight, material, etc., and/or other considerations.

FIG. 11A illustrates the relative dimensions of the components of the cell unit 1100 in the height and width directions/dimensions (not to scale). In the width direction or dimension, the cell has a width 1126 of 6.000 inch, the unit frame 1110 has a thickness 1128 of 0.400 inch on each side of the cell 1102 and the unit wrap 1114 has a thickness 1130 of 0.001 inch. In the height direction or dimension, the cell 1102 has a height 1132 of 6.000 inch (including the terminals 1108), the unit frame has a height 1134 of 0.400 inch, and the recess 1116 may extend a height 1136 in the height dimension by 0.025 inch.

FIG. 11B illustrates the relative dimensions of the components in the thickness direction/dimension (not to scale). In the thickness direction or dimension, the cell 1102 has a thickness 1138 of 0.400 inch, the cell insulators 1112 have a thickness 1140 of 0.001 inch on each side of the cell 1102, and the unit wrap 1114 has a thickness 1142 of 0.001 inch on each side of the cell 1102. As shown in FIG. 11B, the insulator element 1118 may have a thickness 1144 of 0.005 inch.

As a result, in the case of a 0.4 inch thick cell 1102, the electrical insulation from the cell insulators 1112 add +0.002 inch and the thermal insulator in the form of the insulator element 1118 provides for +0.005 inch. This results in a thickness efficiency, which is a ratio of the cell compared to the cell unit, of about 97.8% packing efficiency in the cell thickness direction. In the case of a 6 inch wide cell 1102, the unit wrap 1114 adds +0.002 inch and the unit frame 1110 adds +0.080 inch. This results in a width efficiency of about 98.6% packing efficiency. In the case of a 6″ tall cell 1102, the unit frame 1110 provides for +0.040 inch and the recess 1116 of the vent feature adds +0.025 inch, resulting in 98.9% packing efficiency. Combined, this results in a total volumetric efficiency of over 95%, relative to the cell volume but not specific energy or specific power reduction for the larger mass or volume.

Advantageously, the cell units can include unit frames that provide an air gap between the cells to reduce thermal conductivity (e.g., direct cell-to-cell thermal conductivity) and increase thermal path length. The unit frame includes the recess in the base which can be aligned with a vent of the cell to aid in directing and funneling vent gases. The unit frame may be made from a non-flammable material, such as a material in compliance with the UL standard 94-V0 (e.g., plastics and other composite materials). In some configurations, the unit frame can include a thermal shield that is integral or separate from (e.g., attached to) the unit frame. In some embodiments, such thermal shields may be used to eliminate or replace the above described air gaps or may be used in combination therewith. The unit frame may function as an electrical insulator on the sides of the cell unit.

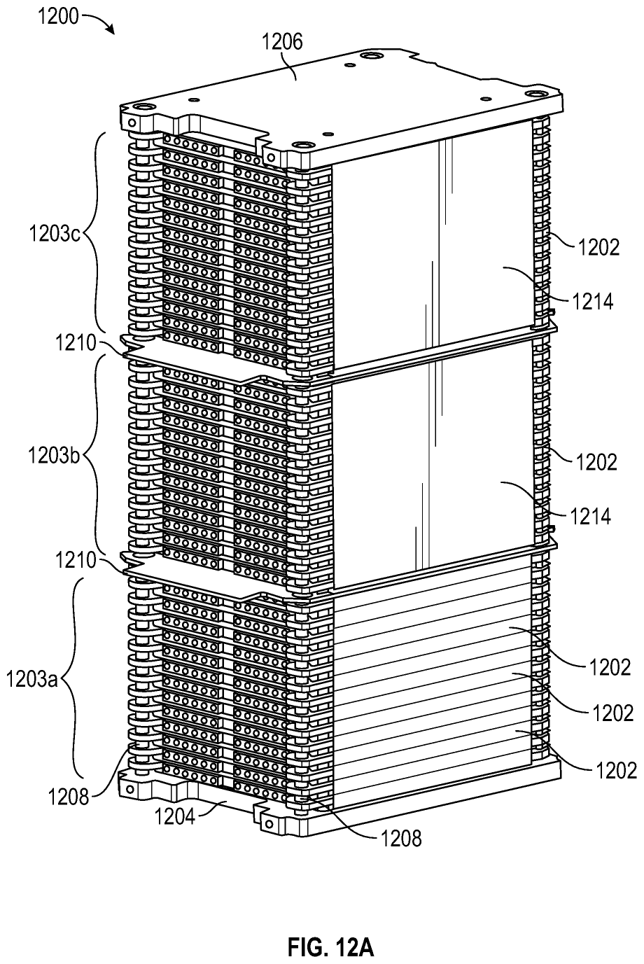

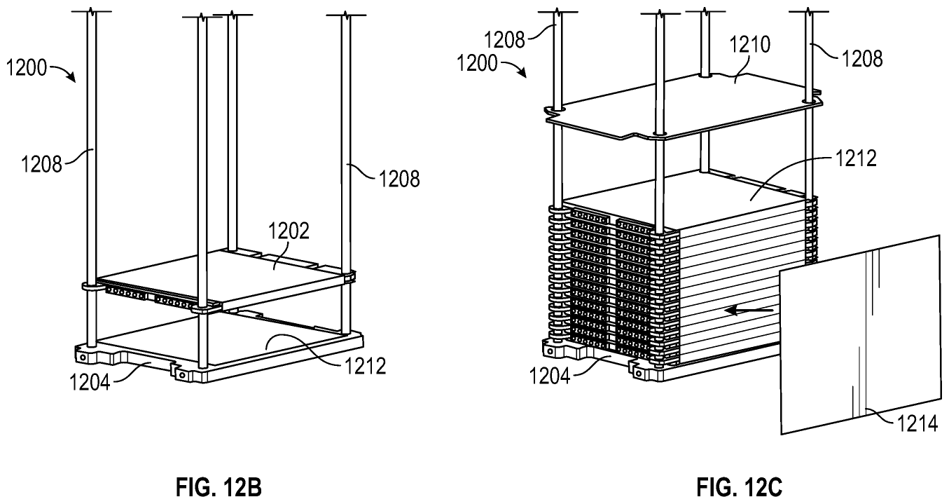

Turning now to FIGS. 12A-12C, schematic illustrations of a battery module 1200 in accordance with an embodiment of the present disclosure are shown. The battery module 1200 includes a plurality of cell units 1202 which may be electrically connected in submodules. In some non-limiting embodiments, the battery module 1200 may be configured to supply a uniform, high rate, high power discharge of electrical power. As shown, the cell units 1202 are stacked to form submodules 1203a, 1203b, 1203c, which are assembled to form the battery module 1200.

In this illustrative embodiment, the cell units 1202 are arranged between a first end plate 1204 and a second end plate 1206 and held in place along tie rods 1208. The tie rods 1208 may pass through mounting features and/or bosses/apertures of the individual cell units 1202. Other mounting features and/or configurations may be employed without departing from the scope of the present disclosure. For example, any feature that allows the cell units to be mutually aligned to the tie rods in a compressively loaded module may be employed. Such features can include, without limitation, clamps, pin-and-slot arrangements, tie rods, ties, snaps, fasters, and the like. Further, in some embodiments, the tie rods may be omitted if the cell units include frames that have attachment/joining features similar to those described herein, including protrusions and recesses that align and join adjacent cell units.

One or more firewalls 1210 may be arranged between groups of the cell units 1202. As shown, the submodules 1203a, 1203b, 1203c are separated by the firewalls 1210. The firewalls 1210 may be configured to minimize propagation of fire if initiated and confine any propagation to the submodules 1203a, 1203b, 1203c, rather than allowing spread through the entire battery module 1200. The firewalls 1210 may include features to align and/or attach the firewalls 1210 to the submodules 1203a, 1203b, 1203c and/or to adjacent cell units 1202 of the submodules 1203a, 1203b, 1203c.

Although this illustrative embodiment includes three submodules 1203a, 1203b, 1203c, it will be appreciated that a battery module of the present disclosure may be formed of a single submodule, two submodules, three submodules, four submodules, or any number of submodules. In this illustrative embodiment, each submodule 1203a, 1203b, 1203c includes fourteen cell units 1202. It will be appreciated that the submodules of the present disclosure may include any desired number of cell units, fewer or greater than the fourteen illustrated here. The number of cell units per submodule may be selected to achieve a desired power capacity and/or power output, for example, or may be based on weight, volume, or other considerations. Additionally, it will be appreciated that the submodules are not required to have an equal number of cell units in each submodule, and in some embodiments, one submodule of a battery module may have more or fewer cell units than another submodule of the battery module.

FIGS. 12B-12C illustrate various stages of assembly of the battery module 1200. As shown in FIG. 12B, the tie rods 1208 extend from the first end plate 1204. The tie rods 1208 may be integrally formed with and part of the first end plate 1204 (or the second end plate 1206), or may be attached thereto by one or more fasteners, welding, bonding, or an adhesive. When assembling the battery module 1200 an insulator element 1212 may be used and arranged between adjacent cell units 1202. The insulator element 1212 may comprise any suitable material (e.g., an aerogel paper, ceramic paper, basalt woven fiber) and/or an air gap, as described above. The insulator element 1212 arranged between adjacent cell units 1202 can enable rapid heat transfer and distribution to something other than an adjacent cell unit(s). For example, the insulator element 1212 can be configured to prevent heat from transferring directly from one cell unit 1202 to an adjacent cell unit 1202. As shown in FIG. 12C, a firewall 1210 may be provided after installation of a group of cell units 1202 and may be arranged between different groups or sets of cell units 1202, as shown in FIG. 12A. The firewall 1210 may be formed from a material having low thermal conductivity and has limited or no flammability. Further, in some embodiments, the firewall 1210 may have a relatively high material or mechanical strength to provide support and/or rigidity to the assembled structure. The selected material may have, for example, a thermal conductivity (e.g., <10 W/mK) that has limited or no flammability (e.g., Flammability Standard UL 94-V0).

The insulator element 1212, in accordance with some embodiments of the present disclosure, may be formed from a material having low thermal conductivity (e.g., <10 W/mK) and may have limited or no flammability (e.g., accordingly to Flammability Standard UL 94-V0). When the insulator element 1212 is arranged between two cell units 1202, the distance between faces of the two adjacent cell units 1202 (through the insulator element 1212) may be, for example, 0.020 inch or less. However, with a strong thermal insulating insulator element 1212, the thermal path to the edges may be 2.5 inch, which is 125 times the distance, ensuring a long thermal path from one cell unit 1202 to another cell unit 1202. The thickness of the insulator elements 1212, in accordance with some non-limiting embodiments, may be of suitable dimensions, such as between 0.005 inch and 0.100 inch, and may be 0.011 inch in thickness. In accordance with some embodiments, the material selection and dimensions of the insulator element 1212 may be selected to obtain a suitable ratio. For example, a ratio of conductor-to-insulator thickness may be optimized to between 1:3 and 1:6 depending on material and usage. It will be appreciated that the purpose of the insulator is to make the thermal path from one cell to an adjacent cell and all other cells in the module more closely comparable than the small distance separating the adjacent cells. As such, the specific dimensions described herein are not to be limiting, but rather are for example purposes only.

FIG. 12A illustrates a thermal transfer device 1214 arranged along a side of the plurality of cell units 1202 and may be arranged in thermal communication with multiple (e.g., three or more) of the cell units 1202 in a given submodule 1203a, 1203b, 1203c. In a non-limiting example, each submodule 1203a, 1203b, 1203c can include one or more thermal transfer devices 1214 arranged along a side of the respective submodule 1203a, 1203b, 1203c and in thermal communication with each of the cell units 1202 of the respective submodule 1203a, 1203b, 1203c. The thermal transfer device 1214 is configured to receive heat from the individual cell units 1202 and distribute said heat across all of the cell units 1202 of the submodule 1203a, 1203b, 1203c. By including an increased thermal path length (e.g., dimension D₀ described above) thermal transfer from the cell units 1202 to the thermal transfer device 1214 can be improved. For example, the increased thermal path (e.g., dimension D₀) can be selected to achieve a higher thermal resistance to adjacent cells (in a stack) than to a lateral distribution of heat through the plane of the thermal transfer device 1214. This can result in a more uniform heat distribution of heat across the thermal transfer device 1214. The uniform heat distribution throughout the thermal transfer device 1214 can distribute the thermal load of a single cell unit 1202 through multiple of the cell units 1202 of the battery module 1200 and/or provide for a more uniform thermal distribution over the entire battery module 1200 (or submodule 1203a, 1203b, 1203c).

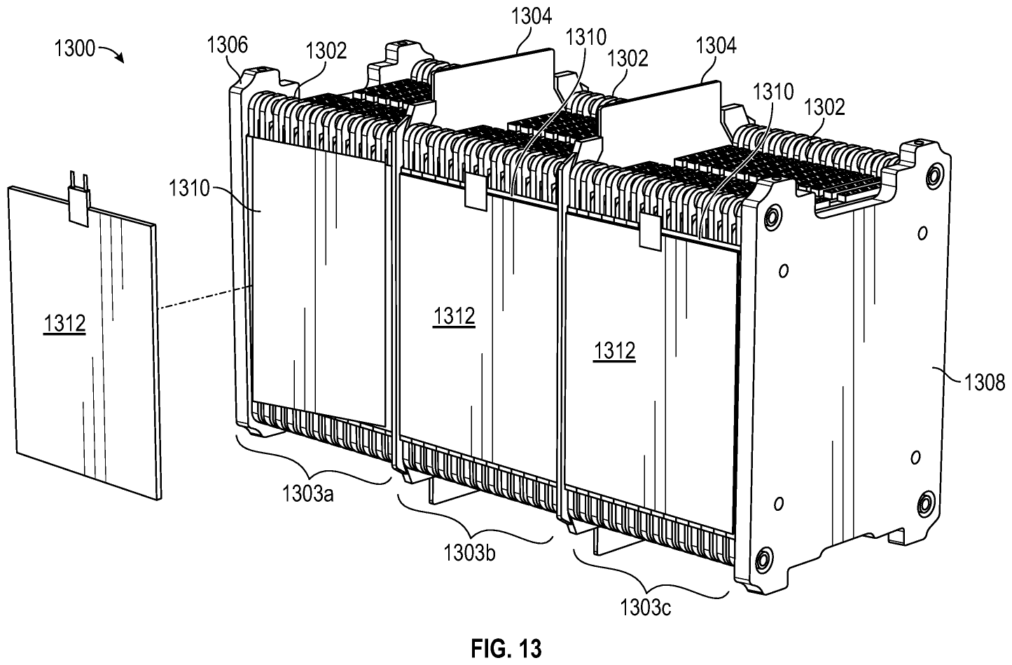

Turning now to FIG. 13, a schematic illustration of a battery module 1300 in accordance with an embodiment of the present disclosure is shown. The battery module 1300 includes a plurality of cell units 1302 arranged in submodules 1303a, 1303b, 1303c with firewalls 1304 arranged therebetween. A first end plate 1306 and a second end plate 1308 are arranged to bound the stack of submodules 1303a, 1303b, 1303c. In this configuration, the battery module 1300 includes one or more thermal transfer devices 1310. The thermal transfer devices 1310 may be in thermal contact with unit frames or external aspects of the individual cell units 1302 to enable adding or removing heat to the individual cell units 1302. In some configurations, the thermal transfer devices 1310 may be attached to provide a thermal pathway to provide uniform heat input to the cell units 1302 of the battery module 1300. In some such embodiments, thermal insulators will be arranged between adjacent cell units 1302 and thus the thermal distribution may be controlled through a combination of thermal insulators and the thermal transfer devices 1310. The thermal transfer devices 1310 may be mounted or otherwise affixed to the battery module 1300 using epoxy and/or thermally conductive adhesives. The thermal transfer devices 1310 may be made from aluminum, pyrolytic graphite, graphene, diamond and/or copper, for example. In other configurations, instead of plates, heat pipes may be employed. Additionally, one or more heaters 1312 may be installed on the thermal transfer devices 1310 to efficiently improve low temperature operation and performance of the battery module 1300. Further, each heater 1312 may extend across one, some, or all cells of a battery module. In some embodiments, the thermal transfer devices 1310 may be bonded or otherwise attached to a surface of the heaters 1312.

In the battery module 1300, the individual cell units 1302 may be designed to direct and distribute heat toward the edges of the individual cell units 1302 (e.g., as described above). This may be achieved through the use of thermal conductors and thermal insulators. However, such movement of heat to the edges may not be sufficient to prevent thermal propagation from one cell unit 1302 to another cell unit 1302. The thermal transfer devices 1310 provide for an additional thermal sink or conductor on the battery module 1300. The thermal transfer devices 1310 can link the thermal masses together so that the energy of a failure of a single cell unit 1302 will quickly spread into and across a large thermal mass, thus limiting the thermal gradients in the event of a failure of a cell unit. The thermal transfer devices 1310, in accordance with some embodiments of the present disclosure, may have any suitable dimensions, such as between 0.005 inch and 0.125 inch. The thermal transfer devices 1310 may be bonded (e.g., welded or epoxied) to the unit frames or the wraps thereout. That is, in some embodiments, the thermal transfer devices 1310 may be affixed and arranged in direct material and thermal connection with the individual cell units 1302 of the battery module 1300. In some embodiments, the thermal transfer devices 1310, or a heater on the thermal transfer device, may include a layer or coating to improve heater efficiency (e.g., on an exterior side of the thermal transfer devices 1310 to direct the heat inward toward the cell units 1302).

In the battery modules of FIGS. 12A-12C and 13, the cell units may all be aligned or oriented in the same direction such that the terminals of the cell units are all exposed on a single side of the battery module. Further, vents of the cell units may also all be arranged and oriented in the same direction/side such that collection, direction, and control of vented gases may be achieved (e.g., away from the terminals or other sensitive components). In some embodiments, additional structures may be provided to direct gas out of the battery module or away from sensitive parts of the battery module. Adjacent cell units may include frames or frame structures that may arrange two or more adjacent cell units into a similar configuration to vent gas through a central location of the multiple adjacent cell units.

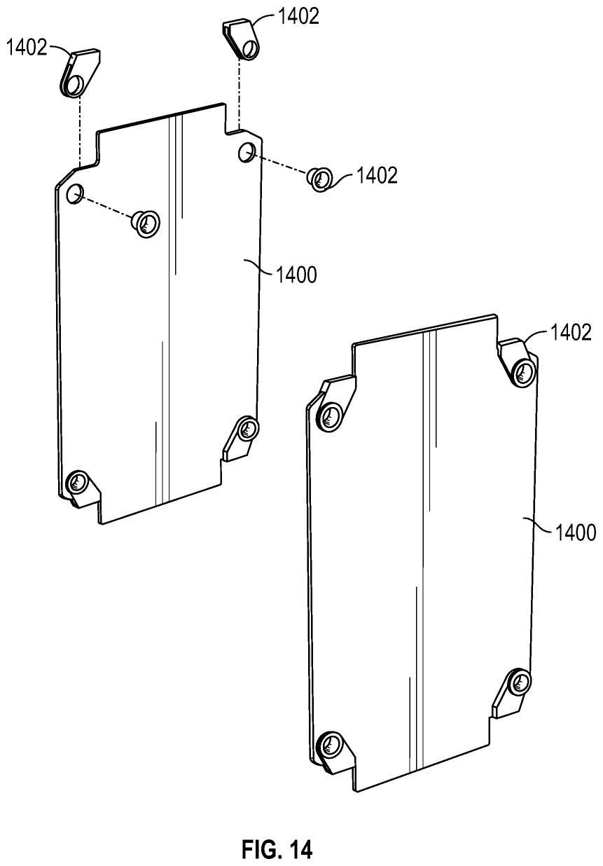

Turning to FIG. 14, schematic illustrations of a firewall 1400 in accordance with an embodiment of the present disclosure are show. The firewall 1400 may be used in a battery module, such as those shown and described herein, and may be arranged between groups of cell units in such battery module. The firewall 1400, as shown, can include one or more optional firewall bumpers 1402. The firewall bumpers 1402 may be arranged to engage with and allow a tie rod to pass therethrough. In the illustrative configuration, the firewall bumpers 1402 comprise a shoulder element and a bushing, and thus are separate elements that may be attached to the firewall 1400. In other embodiments, the firewall bumpers may be multi-piece or single-piece elements attached to the firewall, may be integrally formed with the firewall, or may be omitted entirely. In some embodiments, the firewall bumpers 1402 can be configured to provide structural support and stiffening of the tie rod of the battery module. The firewall 1400 may be made or formed from a material having relatively high material or mechanical strength, limited or no flammability, and should have low thermal conductivity. It will be appreciated that bumpers and bushings are not required but may be used to facilitate assembly. If such bumpers and/or bushing are omitted, other features in the geometry/shape/structure of the firewall may be used for alignment/assembly.

In operation, if a cell unit overheats, gas may need to be expelled from an individual cell unit. Further, it is advantageous to prevent any excess heat from transferring preferentially or directly to other cell units. It will be appreciated that the goal is to transfer heat to all other cell units in the module to minimize any heat gradient and reduce the maximum temperature of a failed cell. Such prevention can prevent cascading overheating of multiple cell units. A mechanism to control heat flow is through the use of the insulators and materials that house the electrochemical elements of the cell units and of the materials and configuration of the battery module when assembled. Further, the use and arrangement of vents within the cell units in combination with the unit frames may be used to help control outgassing from an overheating cell unit.

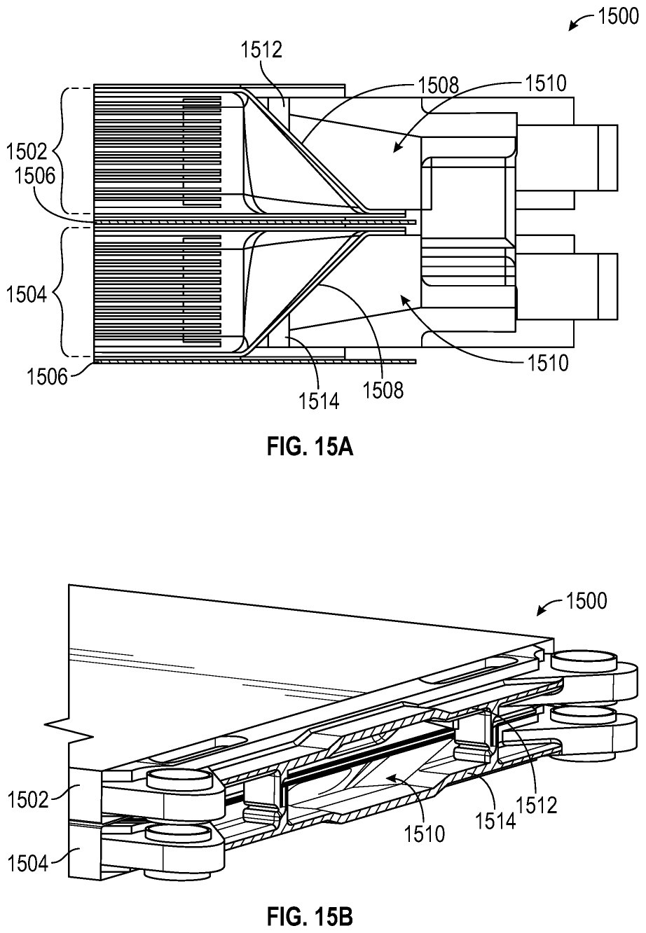

Turning now to FIGS. 15A-15B, schematic illustrations of a portion of a battery module 1500 in accordance with an embodiment of the present disclosure are shown. The battery module 1500, in FIGS. 15A-15B, includes a first cell unit 1502 and a second cell unit 1504. One or more insulator elements 1506 are arranged between and/or to adjacent the first cell unit 1502 and the second cell unit 1504. Each of the first cell unit 1502 and the second cell unit 1504 includes an optional slanted housing sidewall 1508, which may include a vent, as shown and described herein. The arrangement of the first cell unit 1502 and the second cell unit 1504 may define a tray vent structure 1510 when assembled. The tray vent structure 1510 is defined between unit frame bases 1512, 1514 of the adjacent cell units 1502, 1504. The tray vent structure 1510 is designed to aid in collecting and directing vented gases from the cell units 1502, 1504. In the illustrative embodiment, the tray vent structure 1510 is configured to combine vent features of two adjacent cells. However, in other embodiments, each cell may include an individual, dedicated, or discrete tray vent structure (i.e., one tray vent structure for one cell vent).

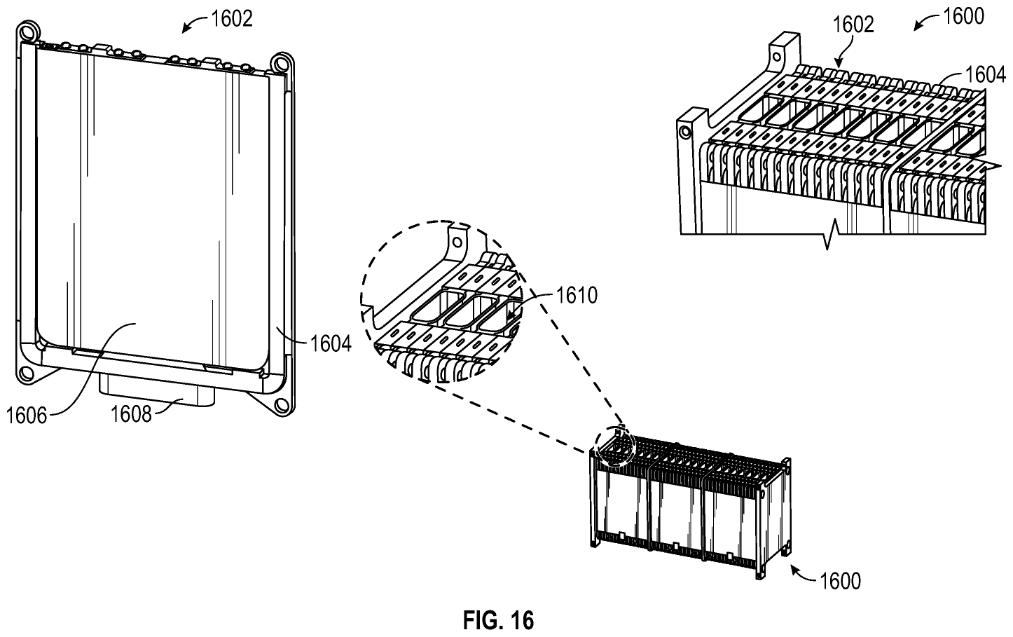

Turning now to FIG. 16, schematic illustrations of a battery module 1600 in accordance with an embodiment of the present disclosure are shown. The battery module 1600 includes a plurality of cell units 1602 arranged or stacked to form the battery module 1600. Each cell unit 1602 includes a unit frame 1604 with a cell 1606 installed therein. The unit frames 1604 may include a frame venting structure 1608 that is different than the recess configuration also disclosed herein. The frame venting structures 1608 of adjacent cell units 1602 may define tray vent structures 1610, having similar functionality as that described with respect to FIGS. 15A-15B. For example, the tray vent structures 1610 may be arranged and coupled to other systems and/or structures to direct gas out of the battery module 1600 or away from sensitive parts of the battery (e.g., terminals, electronic components, etc.). In other embodiments, the tray vent structures may be arranged with a one-to-one relationship with the cell units, such that each tray vent structure corresponds with a single cell unit.

As discussed above, the cell units may be arranged and assembled into battery modules. The battery modules may be assembled into a battery assembly, which comprises one or more battery modules.

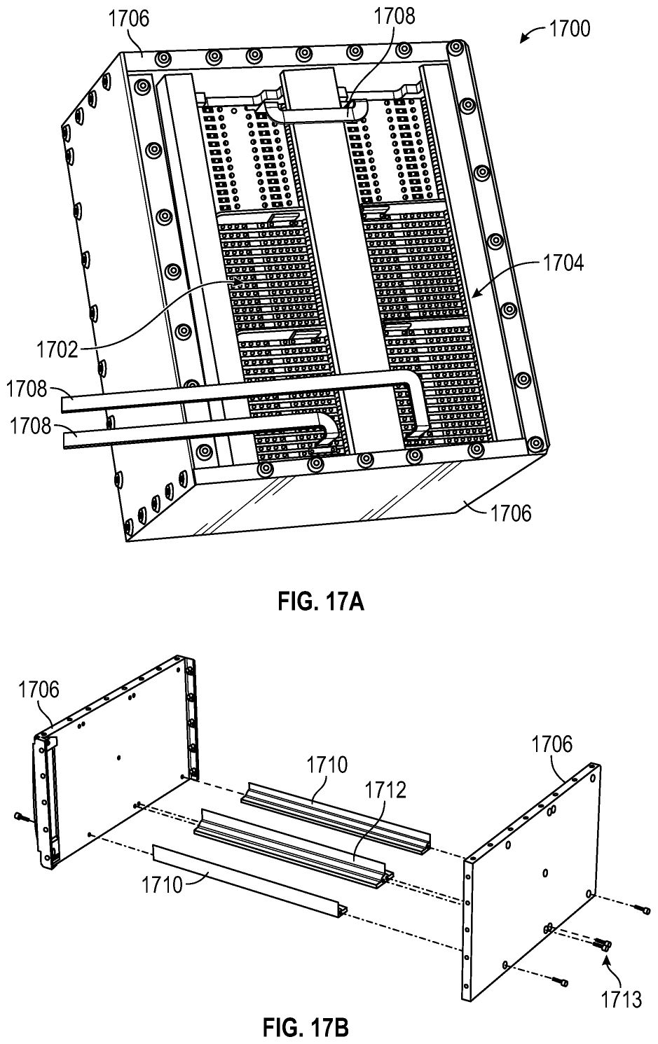

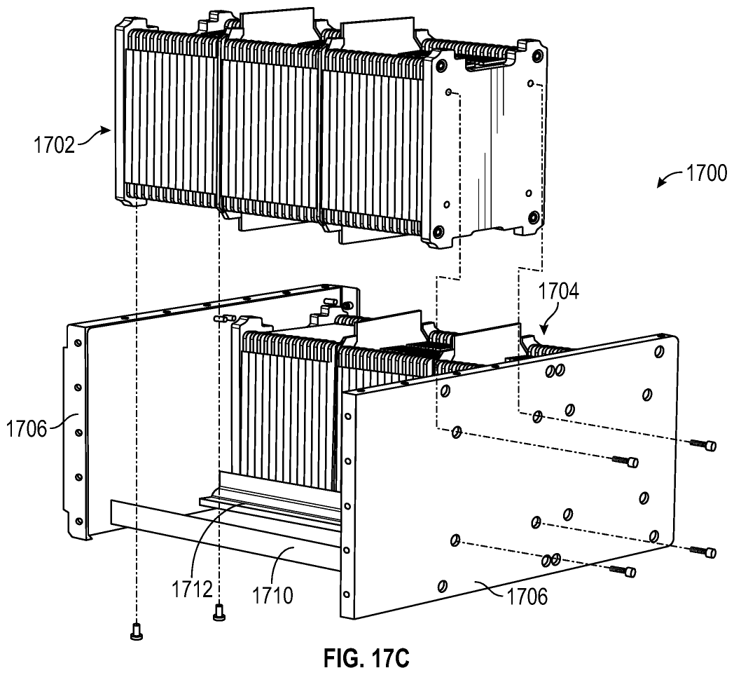

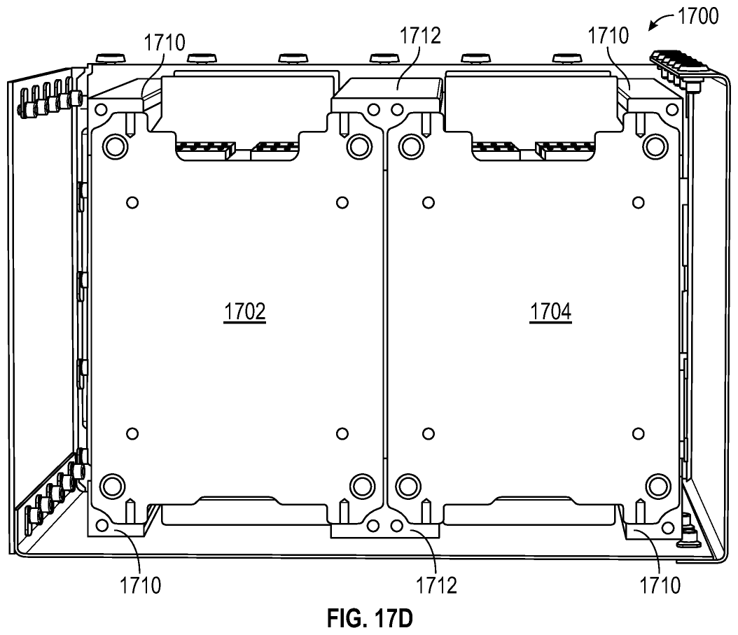

For example, turning now to FIGS. 17A-17D, schematic illustrations of a battery assembly 1700 in accordance with an embodiment of the present disclosure are shown. The battery assembly 1700 includes a first battery module 1702 and a second battery module 1704. The battery modules 1702, 1704 may be assembled within an assembly frame 1706. Although shown with two battery modules 1702, 1704, those of skill in the art will appreciate that any suitable number of battery modules may be employed to form a battery assembly having a desired capability or functionality. Further, each battery module may include a desired number of cell units, and the illustrative embodiment is merely provided for illustrative and explanatory purposes and is not intended to be limiting. The cell units of each battery module may be arranged in serial, parallel, or a combined configuration. In some configurations, the battery assembly 1700 or similar systems and assemblies may be configured to generate up to a 2 kA pulse and a 500 A continuous output, for example, although other power outputs are possible depending on the specific configuration of components and selected elements thereof, as will be appreciated by those of skill in the art.

Each of the battery modules 1702, 1704 may be electrically connected using electrical connectors 1708 (e.g., a wire or a bus bar). The electrical connectors 1708 may be arranged to enable transfer of electrical power to or from the individual cell units of the battery modules 1702, 1704. In some embodiments, the electrical connectors 1708 may be selected and configured to enable high rate, high energy electrical discharge from all of the individual cell units in a single time frame, thus allowing for high energy power discharge to be achieved. The battery modules 1702, 1704 may be substantially identical and there may be symmetry between the battery modules 1702, 1704.

As shown in FIGS. 17B-17D, the assembly frame 1706 can include multiple support rails 1710, 1712. As shown, there are two primary types of support rails: end support rails 1710 and center support rails 1712. As will be appreciated, the end support rails 1710 are configured to support corners of individual battery modules. However, the center support rails 1712 are arranged between the two battery modules 1702, 1704 and thus support corners of two adjacent battery modules. The support rails 1710, 1712 are configured to interface with the battery modules 1702, 1704 and the assembly frame 1706 such that there is minimized or no resonating and/or fatigue generated by the attachment, mounting, support, and operation of the battery modules 1702, 1704 with the battery assembly 1700. The interface between the support rails 1710, 1712 and the battery modules 1702, 1704 may be a direct interface or through a common connection, such as at one or both ends of the rails. The rail structure can provide for less reliance upon an outer enclosure for structural strength and result in a lower weight assembly. The support rails 1710, 1712 may be attached to the assembly frame 1706 by one or more fasteners 1713.

Advantageously, embodiments of the present disclosure provide for an improved battery assembly for high rate discharge. Improved cells, cell units, battery modules, and improved battery assemblies described herein. For the cells and cell units, improved insulation, heat management, and venting are provided.

As used herein, the terms “substantially” is intended to include the degree of error associated with measurement of the particular quantity based upon the equipment available at the time of filing the application. For example, “substantially” can include a range of ±8% or 5%, or 2% of a given value or may refer to deviations from perfect or uniform. Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The term “a plurality” is understood to include any integer number greater than or equal to two, i.e., two, three, four, five, etc. The term “connection” can include an indirect “connection” and a direct “connection”.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description but is only limited by the scope of the appended claims.

1. A cell comprising:
a prismatic shaped cell housing comprising a first portion and a second portion and defining a cell cavity between the first portion and the second portion, wherein cell housing includes a slanted wall;
at least one positive electrode and at least one negative electrode arranged within the cell cavity of the cell housing, wherein the at least one positive and negative electrodes are substantially planar and have a prismatic shape substantially similar to that of the cell housing;
a first terminal connected to the at least one positive electrode at a first position on the cell housing;
a second terminal connected to the at least one negative electrode at a second position of the cell housing,
wherein the slanted wall defines a pocket within the cell housing between edges of the at least one positive electrode and the at least one negative electrode and an interior surface of the slanted wall, wherein the pocket is configured to collect gas generated within the cell housing; and
at least one vent formed at a third position on the slanted wall of the cell housing proximate the pocket, wherein the at least one vent is initially in a closed state and configured to open upon an increase in pressure within the cell cavity and allow pressure and/or gases to leave the cell cavity through the at least one vent.

2.-5. (canceled)

6. The cell of claim 1, wherein each of the first portion and the second portion each include a respective flange and the flanges of the first portion and the second portion are one of jointed or hinged to form a clam-shell configuration or the flanges of the first portion and the second portion are joined to form a bathtub or elongated hemispherical configuration.

7. (canceled)

8. The cell of claim 1, wherein one of the following conditions apply:
(i) the at least one positive electrode and the at least one negative electrode each comprise a plurality of respective electrodes arranged in an electrode stack of alternating positive and negative electrodes;
(ii) the at least one positive electrode and the at least one negative electrode each comprise a plurality of respective electrodes arranged in an electrode stack, the cell further comprising at least one interior housing insulator element arranged between a side of the electrode stack and at least one of the first portion or the second portion; or
(iii) the at least one positive electrode and the at least one negative electrode each comprise a plurality of respective electrodes divided into two or more electrode groups, the cell further comprising at least one divider arranged between each electrode group and an adjacent electrode group.

9. The cell of claim 1, wherein the at least one vent is integrally formed with material of the cell housing.

10. The cell of claim 1, wherein the at least one vent is defined by a section of the cell housing having a material thickness less than a material thickness of the cell housing around the at least one vent.

11. The cell of claim 1, wherein the slanted wall includes at least one additional vent.

12.-17. (canceled)

18. The cell of claim 1, wherein the first portion is a first side of a pouch and the second portion is a second side of the pouch with a midsection defined between the first side and the second side, and wherein the midsection includes one or more terminal apertures configured to allow electrical connection between the first and second terminals and the at least one positive electrode and the at least one negative electrode.

19. (canceled)

20. A cell unit comprising:
a cell comprising at least one positive electrode arranged within a cell housing and electrically connected to a first terminal and at least one negative electrode arranged within the cell housing and electrically connected to a second terminal, wherein the first terminal extends from the cell housing at a first position and the second terminal extends from the cell housing at a second position; and
a unit frame configured to receive and support the cell, the unit frame having at least one open section configured to receive the first terminal and the second terminal and provide access thereto, wherein the unit frame comprises a recess on the frame arranged away from the at least one open section, the recess configured to collect and direct gas away from the cell in the event of a leak of gas from the cell, the unit frame having a dimension in a direction that in in-plane with the cell when installed within the frame, wherein the dimension is between 0.05 inch and 0.5 inch, inclusive.

21. The cell unit of claim 20, wherein the unit frame comprises a base, a first arm, a second arm, and an open end opposite the base defined by the at least one open section; and wherein the unit frame defines a plurality of corners at ends of the arms and at junctions of the arms with the base, and the unit frame includes a mounting feature at each of the corners.

22. (canceled)

23. The cell unit of claim 20, wherein the cell includes at least one vent at a third position and the at least one vent is substantially aligned with the recess of the unit frame.

24.-34. (canceled)

35. The cell unit of claim 20, wherein the unit frame comprises at least one air gap defined by a channel within a portion of the unit frame.

36.-39. (canceled)

40. A battery module comprising:
a first end plate and a second end plate configured to support one or more tie rods therebetween;
a plurality of cell units attached to the one or more tie rods and compressively loaded between the first end plate and the second end plate, wherein each cell unit comprises a unit frame and a cell installed within the unit frame, wherein the cell includes a vent configured to direct gas away from an interior of the cell and the unit frame includes a recess aligned with the vent and configured to direct the gas away from the cell and the unit frame, and each cell unit comprises an insulator and a unit wrap structure wrapped about the cell, the frame, and the insulator; and
an insulator element arranged between adjacent cell units of the plurality of cell units,
wherein all cell units of the plurality of cell units are oriented so that the vents are on a side of the cell unit that does not include terminals of the cell units.

41. The battery module of claim 40, wherein the plurality of cell units define at least a first group of cell units and a second group of cell units, the battery module further comprising a firewall arranged between the first group of cell units and the second group of cell units.

42.-43. (canceled)

44. The battery module of claim 40, further comprising a thermal transfer device arranged along a side of the plurality of cell units and arranged in contact and thermal communication with the unit wrap structure of at least two cell units to distribute heat between the cell units the thermal transfer device is in contact with.

45.-47. (canceled)

48. The battery module of claim 44, further comprising a heater installed on the thermal transfer device.

49. (canceled)

50. The battery module of claim 40, wherein the plurality of cell units includes a first cell unit adjacent a second cell unit, wherein a tray vent structure is defined by the adjacent first and second cell units, wherein the tray vent structure is configured to collect and direct gases vented from one or both of the first and second cell units.

51. The battery module of claim 40, wherein each cell unit of the plurality of cell units comprises:
a cell comprising at least one positive electrode arranged within a cell housing and electrically connected to a first terminal and at least one negative electrode arranged within the cell housing and electrically connected to a second terminal, wherein the first terminal extends from the cell housing at a first position and the second terminal extends from the cell housing at a second position;
a unit frame configured to receive and support the cell, the unit frame having a first open section configured to receive the first terminal and a second open section configured to receive the second terminal and provide access thereto.

52. The battery module of claim 40, wherein each cell unit of the plurality of cell units comprises:
a cell housing comprising a first portion and a second portion and defining a cell cavity between the first portion and the second portion;
at least one positive electrode and at least one negative electrode arranged within the cell cavity of the cell housing;
a first terminal connected to the at least one positive electrode at a first position on the cell housing;
a second terminal connected to the at least one negative electrode at a second position of the cell housing;
at least one vent formed at a third position on the cell housing, wherein the at least one vent is initially in a closed state and configured to open upon an increase in pressure within the cell cavity and allow pressure and/or gases to leave the cell cavity through the at least one vent.

53. A battery assembly comprising:
an assembly frame;
a first battery module and a second battery module arranged within the assembly frame, wherein each battery module independently comprises the battery module of claim 40:
an insulator element arranged between adjacent cell units of the plurality of cell units,
wherein all cell units of the plurality of cell units are oriented so that the vents are on a side of the cell unit that does not include terminals of the cell units; and
an electrical connector electrically connecting the first battery module to the second battery module.

54. The battery assembly of claim 53, wherein the assembly frame comprises one or more end support rails configured to support at least one of the first battery module or the second battery module within the assembly framer; and/or the assembly frame comprises one or more center support rails configured to support each of the first battery module and the second battery module within the assembly frame.

55.-60. (canceled)
